(19) United States
(12) Patent Application Publication
(10) Pub. No.: US 2022/0138562 A1
(43) Pub. Date: May 5, 2022

(54) METHOD FOR CREATING AN ARTIFICIAL NEURAL NETWORK (ANN) WITH ID-SPLINE-BASED ACTIVATION FUNCTION

(71) Applicant: Tatiana Biryukova, Moscow (RU)

(72) Inventor: Tatiana Biryukova, Moscow (RU)

(21) Appl. No.: 17/324,681

(22) Filed: May 19, 2021

(30) Foreign Application Priority Data
Nov. 1, 2020 (RU) 2020135883

(51) Int. Cl. G06N 3/08; G06N 3/04; G06F 17/12

(52) U.S. Cl. CPC G06N 3/08; G06F 17/12; G06N 3/0481

(57) ABSTRACT

The present technical solution relates to the field of artificial intelligence, particularly a computer-implemented method for creating a trained instance of an artificial neural network (ANN), comprising the following steps:
defining an ANN structure and hyperparameters;
creating, by at least one processor, the ANN to be stored in a memory based on the defined ANN structure and hyperparameters, the ANN comprising an ANN input layer, one or more ANN hidden layers, an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential (integrodifferential) spline

$${S}_{2 ID} ( x ) = {{⋃}^{n - 1}}_{i = 0} {S}_{2 ID , i} ( x ) , \qquad$$

the parabolic integro-differential spline (parabolic integrodifferential spline) having coefficients of parabolic polynomials S_{2ID,i}(x), which comprise trainable (learnable) parameters and change when training the created ANN; and
training the instance of the created ANN.

### FIELD OF INVENTION

The present technical solution relates to the field of artificial intelligence, particularly to artificial neural networks (ANN).

### DESCRIPTION OF THE RELATED ART

The prior art includes a technical solution disclosed in the Chinese patent application CN107122825A “Activation function generation method of neural network model”, by UNIV SOUTH CHINA TECH, that teaches about a method for generating an activation function for a neural network model, the method including the following steps: selecting a plurality of basic activation functions; combining the plurality of basic activation functions that were selected in the first step into the activation function for the neural network model; wherein the activation function is updated in each iteration.

Another conventional solution disclosed in the Chinese patent application CN109508784A “A design method of neural network activation function”, by SICHUAN NADS TECH CO LTD, teaches about a method for developing the activation function for a neural network, the method including following steps: developing a neural network structure, choosing a saturation activation function as a neural network activation function, testing and training of a neural network.

These conventional technical solutions are unable to provide the same accuracy of results, as claimed in the present disclosure, when operating within an already trained ANN instance.

### SUMMARY OF THE INVENTION

The objective of the present technical solution is to increase the accuracy of the results produced by the trained ANN instance. An additional objective is to increase the speed of training of an ANN instance using certain embodiments of the present solution, such as embeddings or matrix solutions of systems of linear equations.

In some embodiments, some or all steps of the method for creating an artificial neural network (ANN), and/or method for using an ANN instance, as disclosed herein, may further comprise processing of data/information/parameters performed by one or more processing units, particularly GPUs, wherein the data to be processed are loaded from the memory, particularly a video RAM. In some embodiments, special data handling instructions can be used that are supported by the processing unit, such as MMX, SSE or FMA.

The objective is achieved by using a computer-implemented method for creating a trained instance of an artificial neural network (ANN), comprising the following steps:

defining an ANN structure and hyperparameters (FIG. 10, 1001);

creating (FIG. 10, 1002), by at least one processor, the ANN to be stored in a memory based on the defined ANN structure and hyperparameters, the ANN comprising an ANN input layer, one or more ANN hidden layers, an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential spline (parabolic integrodifferential spline)

$${S}_{2 I D} ( x ) = {{⋃}_{i = 0}}^{n - 1} {S}_{2 I D , i} ( x ) , \qquad$$

the parabolic integro-differential spline having coefficients of parabolic polynomials S_{2ID, i}(x), which comprise trainable (learnable) parameters and change when training the created ANN; and
training the instance of the created ANN (FIG. 10, 1003).

In some embodiments, the activation function representing a parabolic integro-differential spline is defined individually for each neuron of the ANN layer where the activation function is used.

In some embodiments, the activation function comprising a parabolic integro-differential spline is defined individually for each neuron of the ANN layer where the activation function is used.

In some embodiments, the activation function representing a parabolic integro-differential spline is defined individually for each ANN layer where the activation function is used.

In some embodiments, the activation function comprising a parabolic integro-differential spline is defined individually for each ANN layer where the activation function is used.

In some embodiments, the activation function is defined individually for each neuron of a certain ANN layer.

In some embodiments, the activation function is defined individually for each ANN layer.

In some embodiments, the step of using an activation function is among the steps performed by neurons of a certain ANN layer. In this case, the ANN layer is provided with the activation function (i.e. the activation function is itself a part of the ANN layer).

In some embodiments, the activation function is a separate layer (an activation layer) of the ANN.

In some embodiments, the step of using an activation function representing or comprising a parabolic integro-differential spline is among the steps performed by neurons of a certain ANN layer. In this case, the ANN layer is provided with the activation function representing or comprising the parabolic integro-differential spline (i.e. the activation function representing or comprising a parabolic integro-differential spline is itself a part of the ANN layer).

In some embodiments, the activation function representing or comprising a parabolic integro-differential spline is a separate layer (an activation layer) of the ANN.

In some embodiments, the ANN layer with the activation function representing or comprising the parabolic integro-differential spline comprises an embedding layer configured such that the parameters of the activation function are trained.

In some embodiments, the ANN layer used as the activation function representing or comprising the parabolic integro-differential spline comprises an embedding layer configured such that the parameters of the activation function are trained.

In some embodiments, the parameters included in the coefficients of the parabolic integro-differential spline used as the activation function or comprising a part thereof are determined by using a matrix solution of a system of linear equations.

The objective is achieved by performing a computer-implemented method for using a trained instance of an artificial neural network (ANN), comprising the following steps: receiving and feeding input data (FIG. 11, 1101) to an input layer of the trained instance of the ANN, the ANN being created based on a predefined ANN structure and predefined ANN hyperparameters by using at least one processor, the ANN comprising an ANN input layer, one or more ANN hidden layers, and an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential spline

$${S}_{2 I D} ( x ) = {{⋃}_{i = 0}}^{n - 1} {S}_{2 I D , i} ( x ) , \qquad$$

the parabolic integro-differential spline having coefficients of parabolic polynomials S_{2ID,i}(x) , which comprise trainable parameters and change when training the created ANN; and

processing (FIG. 11, 1102) the input data by using the trained instance of the ANN, thereby obtaining a resulting output (FIG. 11, 1103).

In some embodiments, the technical solution represents a system configured to perform the computer-implemented method for using a trained instance of an artificial neural network (ANN).

In some embodiments, the technical solution represents a system configured to perform the computer-implemented method for creating a trained instance of an artificial neural network (ANN).

In some embodiments, the computer-implemented method/system for using a trained instance of an artificial neural network (ANN) may use an ANN instance that has been provided (trained, generated) by the computer-implemented method/system for creating a trained instance of an artificial neural network (ANN).

The activation function used in the technical solution disclosed herein represents or comprises a parabolic integro-differential spline (parabolic integrodifferential spline) having configurable/trainable/ learnable parameters, and may be used in an ANN of an architecture constructed by a system user or developer as well as in an ANN of known (existing) architecture.

In some embodiments, the ANN is created such that it has one or more activation functions representing or comprising parabolic integro-differential splines.

In some embodiments, the ANN is created by replacing one or more activation functions of an ANN having a known (existing) architecture (in some cases, it is provided by a known software library) with the activation functions representing or comprising the parabolic integro-differential splines.

In some embodiments, the ANN is created by replacing one or more activation functions of an ANN having a known (existing) architecture (in some cases, it is provided by a known software library) with the activation functions representing or comprising the parabolic integro-differential splines, and pre-trained (i.e. known before a training process and, in some cases, provided by a known software library) neuron weights are used in the training process.

### BRIEF DESCRIPTION OF DRAWINGS

FIG. 1 illustrates the architecture of an artificial neural network (ANN).

FIG. 2 illustrates the process of signal processing by a single neuron in the ANN.

FIG. 3 illustrates the architecture of an ANN being used to classify images of cats.

FIG. 4 illustrates the architecture of an auto-encoder for images of handwirtten digits.

FIG. 5 illustrates an exemplary random sample from the FashionMlST dataset.

FIG. 6 shows the ID-spline-based activation function (IDSAF) that is called after the first pair of layers {Conv2d, BatchNorm2d} are executed, before training (left panel) and after training (right panel) of the IDSplineNet neural network.

FIG. 7 shows the ID-spline-based activation function (IDSAF) that is called after the second pair of layers {Conv2d, BatchNorm2d} are executed, before training (left panel) and after training (right panel) of the IDSplineNet neural network.

FIG. 8 shows the ID-spline-based activation function (IDSAF) that is called after the second pair of layers {Conv2d, BatchNorm2d} are executed, before training (left panel) and after training (right panel) of the RelulDSplineNet neural network.

FIG. 9 shows an exemplary general-purpose computer system that is used to implement the proposed technical solution in some embodiments.

FIG. 10 is an exemplary general diagram of creating an ANN instance.

FIG. 11 is an exemplary general diagram of using the ANN instance that has been created according to the process shown in FIG. 10.

### DETAILED DESCRIPTION OF THE PREFERRED EMBODIMENTS

The neuron's activation function (also transfer, or network function) determines its output signal, which, in turn, is determined by an input signal or a set thereof

An artificial neural network (ANN) is a nonlinear computational model based on the neural structure of the human brain, which is capable of training to perform classification, prediction, decision making, control, visualization, approximation, and, but not limited to, processing of images, videos, texts, speeches, music, etc.

An ANN is a system of interconnected and interacting simple processing units (artificial neurons). Each unit in such network deals with signals that it receives and sends to other units at certain intervals only. Nonetheless, when connected into a large enough network with controlled interaction, such individually simple units are capable of performing complex tasks.

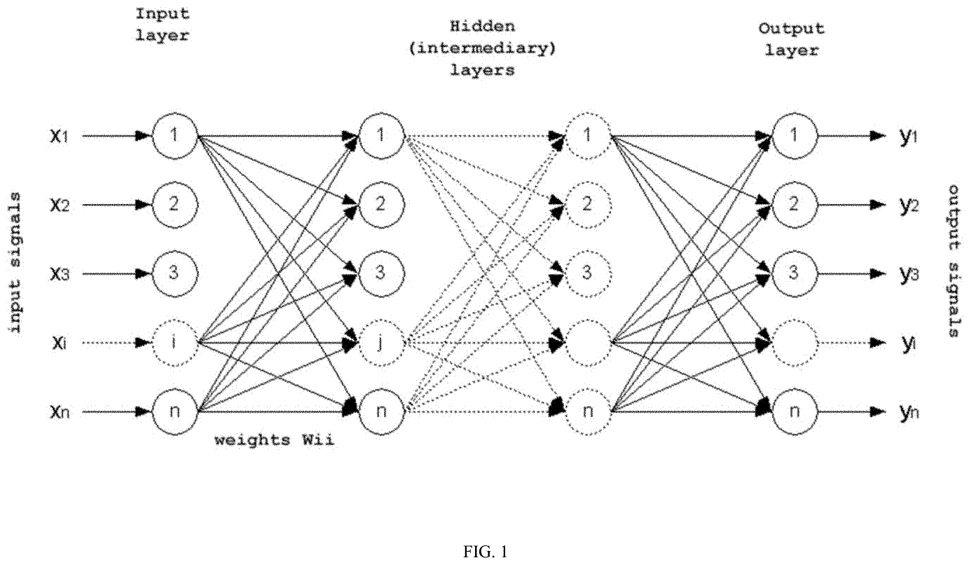

The architecture of an ANN (FIG. 1) represents a set of three or more interconnected neuron layers: an input layer, a hidden layer (that may comprise one or more layers), and an output layer. Each layer is a set of neurons that process signals in a similar way.

The input layer comprises input neurons that transfer data to the hidden layer, which, in turn, transfers data to the next hidden layer or to the output layer. Each neuron in a hidden layer and in the output layer receives signals from neurons of previous layer, calculates their weighted sum and then calculates the output signal by applying an activation function to this sum. (In some cases, the output layer does not contain an activation function). Neuron weights characterize connections between neurons and represent regulated (trained) ANN parameters.

An ANN with multiple hidden layers is known as a deep neural network (DNN).

A neuron has several input channels and only one output channel. Through input channels, the neuron receives the task data, and through the output channel, it produces a result. The neuron calculates a weighted sum of input signals, and then converts the sum using a given (usually, nonlinear) function known as an activation function. A set comprising all the weights and, in some cases, bias (which is also considered a weight in literature) is known as neuron parameters. The bias is a configured parameter that shifts the neuron's output signal.

Neuron weights in a neural network are trainable (learnable) parameters. At each training iteration, all neuron weights in the neural network are corrected in order to produce the best result for the task at hand.

The neural network architecture is usually formed such that, for certain neural network layers, the set of output signals is generated after “passing” through the activation function, i.e. each element of a (generally) multidimensional number array representing a set of signals has to pass through the activation function.

In some sources, it is considered that the step of using an activation function is among the steps performed by the neurons of a certain layer.

In some sources, the activation function is considered a separate layer (an activation layer) of the ANN.

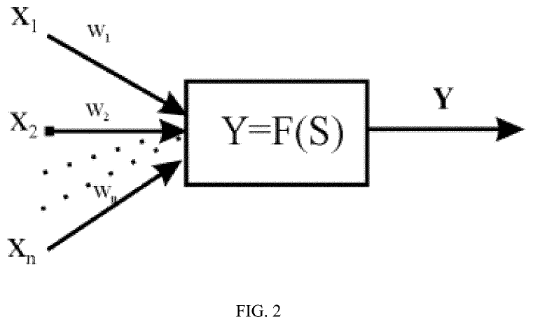

Let X₁, X₂, . . . , Xₙ be input signals of the neuron (see FIG. 2), w₁, w₂, . . . , wₙ be weight coefficients of the neuron, and b be the bias.

First, the neuron calculates the weighted sum

$$= {\sum }_{i} {w}_{i} {X}_{i} + b ,$$

then it calculates the output signal Y=F(\tilde{X}) using the activation function F(\tilde{X}).

There are several types of the most common activation functions known in the art, such as linear, step, sigmoid, tangential, rectified (Rectified linear unit, ReLU), Leaky ReLU, ELU (Exponential Linear Unit), etc.

The method for creating a neural network disclosed herein, training an instance of the ANN, and the activation function according to the claimed technical solution can be applied to all known ANN architectures, such as, but not limited to, the perceptron (both single-layer and multi-layer), recurrent neural networks, convolutional neural networks, autoencoders, and generative adversarial networks (GAN).

The architecture of the ANN depends on a task to be completed and may vary without causing any limitation to the technical solution disclosed herein.

The computer-implemented method for creating a trained instance of a generated artificial neural network (ANN) comprises the following steps described below.

Defining an ANN Structure and Hyperparameters.

In some embodiments, ‘defining’ means receiving and sending data (data structures) from and to different processes and/or procedures, and/or functions, and/or remote receiving and sending of data (via a computer network, RPC). Specific implementations thereof bear no significance for the scope of the claimed technical solution.

Hyperparameters (of a model/ANN) are parameters that are set before the training of a model (ANN) starts. These parameters do not change during training, or are changed based on a specific rule, depending, for example, on the number of training iteration or the value of an error function (that characterizes the quality of the neural network), or some other indicators.

Among hyperparameters are the number of layers in a neural network, the number of neurons in each layer, the size of a data packet (batch) that is inputted into the neural network in a single training iteration, the learning rate, etc.

In some embodiments, the structure (configuration) of an ANN represents a set of layers of certain types, with a given order and type of each layer, as well as input and output nodes being used. For instance, the structure of an ANN can be configured as follows (the fragment below is written in Python using the Keras software library):

model.add(layers.Dense(output dim=128, input dim=784, activation=‘elu’))//description of the first (input) layer (128 output nodes/neurons; 784 input nodes/neurons; activation function: elu) model.add(layers.Dense(output_dim=64, activation=‘elu’))//description of the hidden layer (64 output nodes/neurons; activation function: elu) model.add(layers.Dense(output_dim=10, activation=‘softmax’))//description of the output layer (10 output nodes/neurons; activation function: ‘softmax’)

In some embodiments, the neural network layers may be represented by, but not limited to, fully connected layers, convolutional layers, recurrent layers, pooling layers, upsampling layers, normalization layers, or dropout layers.

The structure (architecture) of an ANN is defined based on the scope of tasks and application.

In order to establish optimal hyperparameters for the neural network, various algorithms for hyperparameter configuration can be used.

The activation function used in the technical solution disclosed herein that represents or comprises a parabolic integro-differential spline having configurable/trainable/learnable parameters may be used both in an ANN having an architecture selected by a system user or developer and in an ANN having a known (existing) architecture.

For instance, for the purposes of classifying items of clothing, a user or developer may form the following ANN architecture (the layers are listed in the order of their locations): Conv2d, BatchNorm2d, AF, MaxPool2d, Conv2d, BatchNorm2d, AF, MaxPool2d, Dropout, Linear, Softmax,

where AF is the activation function, and the other layers are listed as the corresponding classes from the torch.nn module of the PyTorch software library. The AF may be represented by a parabolic integro-differential spline, such as one described in the present technical solution, or by another activation function (or a combination thereof).

Activation functions (one or more) of the ANNs with known architectures can be replaced by the activation functions described herein, which represent or comprise parabolic integro-differential splines.

Possible examples topologies (architectures) of artificial neural networks, in which one or more activation functions can be replaced by activation functions described herein, which represent or comprise parabolic integro-differential splines, include, but are not limited to, LeNet, AlexNet, VGG, ResNet, SqueezeNet, DenseNet, Inception, GoogLeNet, ShuffleNet, MobileNet, ResNeXt, Wide ResNet, NASNet, Overheat, Network-in-network, ENet, SEResNet, Dual path, U-Net, Mask-RCNN, Faster-RCNN, KeyPoint-RCNN, YOLO, SSD, ResNet 3D 18, ResNet MC 18, ResNet (2+1)D, EfficientNets,Vanilla, WaveNet (as well as all their derived architectures and modifications).

Modified architectures (i.e. that use activation functions representing or comprising parabolic integro-differential splines) allow to improve efficiency and accuracy of neural networks in various areas. For instance (the examples below are for illustrative purposes only and should not be considered as limiting to the scope of the claimed technical solution), the activation functions described herein, that represent or comprise parabolic integro-differential splines, are used in the following neural networks (architectures) and their modifications: AlexNet, VGG, ResNet, SqueezeNet, DenseNet, Inception, GoogLeNet, ShuffleNet, MobileNet, ResNeXt, Wide ResNet, NASNet (that are used to classify images); Faster-RCNN, KeyPoint-RCNN, YOLO, SSD (that are used to recognize objects in photos); U-Net, Mask-RCNN (that are used to segment images, i.e. to sparate objects from the background); ResNet 3D 18, ResNet MC 18, ResNet (2+1)D (that are used in video classification); Vanilla (that is used for autoencoding tasks); WaveNet (that is used to generate music).

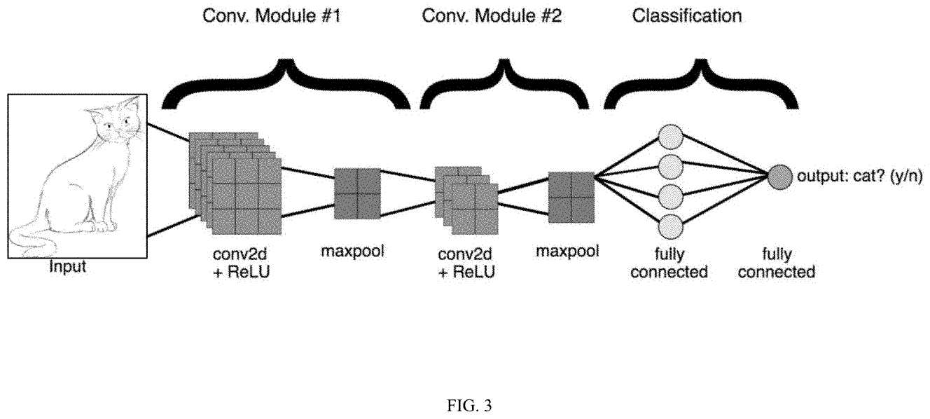

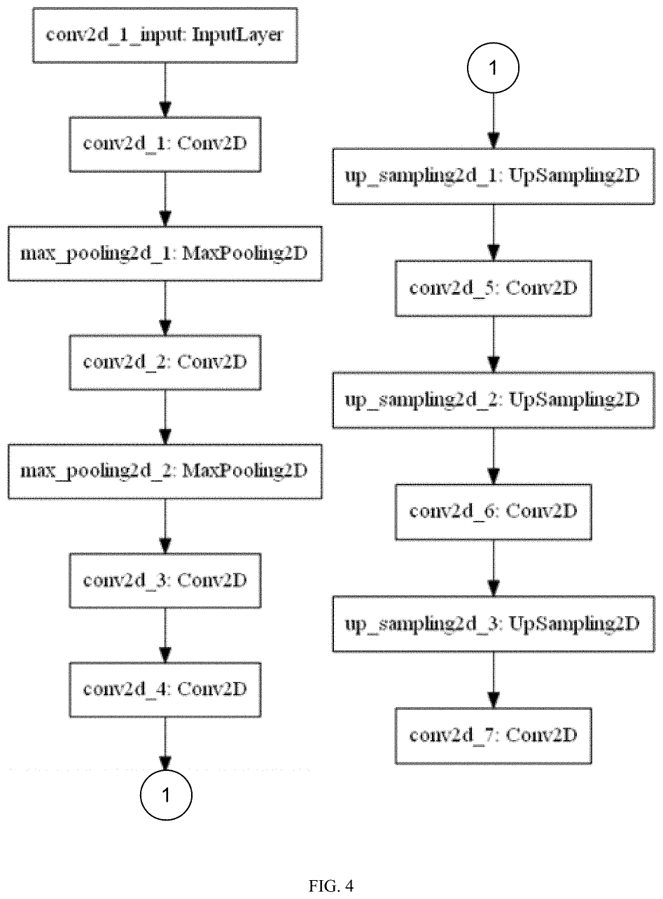

As an illustrative example, the architecture shown in FIG. 3 can be used to classify images with cats, and the architecture shown in FIG. 4 can be used as an autoencoder for images of handwritten digits (https://www.machinecurve.com/index.php/2019/12/11/upsampling2d-how-to-use-upsampling-with-keras/).

In some embodiments, recurrent neural networks, such as LSTM, RNN, or GRU, can be modified using activation functions representing or comprising parabolic integro-differential splines described herein. In this case, recurrent ANNs use activation functions representing or comprising parabolic integro-differential splines instead of “sigmoid” and “hyperbolic tangent” functions in formulas for calculating hidden state vectors or, in case of LTSM, for calculating cell state vectors. Such activation functions replace all or some “sigmoid” and “hyperbolic tangent” functions in these formulas. In this case, the corresponding activation functions should be pre-initialized with the functions of the “sigmoid” or “hyperbolic tangent”. Then, the parameters of the activation functions representing or comprising parabolic integro-differential splines are modified (trained) so as to improve the accuracy of results produced by the ANN when it is being trained.

ANN architectures used in certain implementations should not be seen as limiting to the claimed technical solution.

Creating, by at least one processor, the ANN to be stored in Random Access Memory (RAM) based on the defined ANN structure and hyperparameters, the ANN comprising an ANN input layer, one or more ANN hidden layers, an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential (integrodifferential) spline

$${S}_{2 I D} ( x ) = {{⋃}_{i = 0}}^{n - 1} {S}_{2 I D , i} ( x ) , \qquad$$

the parabolic integro-differential spline having coefficients of parabolic polynomials S_{2ID, t}(x), which comprise trainable (learnable) parameters (represent trainable (learnable) parameters) and change when training the created ANN.

Also, the term “parabolic integro-differential spline” (“parabolic integrodifferential spline”) is interchangeable with a similar term “ID-spline”.

The activation function used that represents or comprises an ID-spline having trainable parameters is modified during the training of the neural network so as to improve the accuracy of the neural network.

During training, an ID-spline may flexibly respond to changes in signals that are transmitted between the nodes in a neural network by modifying the coefficients in its constituent polynomials. The form of the activation function representing or comprising an ID-spline is also changed during training.

In some embodiments of the proposed technical solution, the activation function represents an ID-spline.

In some embodiments, input signals of a neuron are converted to output signals depending on values of argument x such that the output signal is calculated/determined in one range of values of argument x by using the activation function representing the ID-spline and in other range(s) of values of argument x by using other function(s) (the activation function, then, comprises/includes the ID-spline).

In some embodiments of the proposed technical solution, the activation function comprises an ID-spline, having, e.g. the following form (but not limited to it):

$$A ( x ) = \{ \begin{matrix}G ( x ) & x < {\overline{x}}_{{begin \_ S}_{ID 2}} \\ {S}_{2 I D} ( x ) & x \geq {\overline{x}}_{{begin \_S}_{ID 2}}\end{matrix} , \qquad$$

where S_{2ID}(X) is an ID-spline, G (x) is a function, and x̅_{begin_S}_{_{ID2}} is a real number.

In some embodiments, the activation function comprises an ID-spline, having, e.g. the following form (but not limited to it):

$$A ( x ) = \{ \begin{matrix}G ( x ) & x \leq {\overline{x}}_{{begin \_ S}_{ID 2}} \\ {S}_{2 I D} ( x ) & x \geq {\overline{x}}_{{begin \_S}_{ID 2}}\end{matrix} , \\ where G ( {\overline{x}}_{{begin \_ S}_{ID 2}} ) = {S}_{2 ID} ( {\overline{x}}_{{begin \_ S}_{ID 2}} )$$

is a condition for joining a function G (x) and an ID-spline S_{2ID}(x) in the point x̅_{begin_S}_{_{ID2}} (x̅_{begin_S}_{_{ID2}} is a real number).

An activation function representing a parabolic integro-differential spline (ID-spline) is defined as an ID-spline-based activation function.

An activation function comprising an ID-spline is defined as a combined ID-spline-based activation function.

Polynomials S_{2ID,i} (x) that make up an ID-spline are known as ID-spline links.

The formula of the ith link (i=0, . . . , n−1) of the ID-spline on the segment [x̅ᵢ, x̅ᵢ₊₁] (where x̅ᵢ, x̅ᵢ₊₁ are nodes of the grid θ={x̅₀, x̅₁, . . . , x̅, . . . , x̅ₙ}, where x̅₀<x̅₁< . . . <x̅ᵢ< . . . <x̅ₙ are real numbers (grid nodes)) is represented by the following parabolic polynomial:

$${S}_{2 I D , i} ( x ) = {f}_{i} + ( \frac{6 ∇ {I}_{i}^{i + 1}}{{h}_{i + 1}^{2}} - \frac{2 {Δ}_{i + 1}}{{h}_{i + 1}} ) ( x - {\overline{x}}_{i} ) + ( - \frac{6 ∇ {I}_{i}^{i + 1}}{{h}_{i + 1}^{3}} + \frac{3 Δ {f}_{i + 1}}{{h}_{i + 1}^{2}} ) {( x - {\overline{x}}_{i} )}^{2} , \qquad ( 1 )$$

where
hᵢ₊₁=x̅ᵢ₊₁−x̅ᵢ;
Iᵢⁱ⁺¹=∫_{x̅}_{ᵢ}^{x̅}^{ᵢ₊₁}S_{2ID,i} (x)dx are integral parameters of the ID-spline;
fᵢ=S_{2ID,i}(x̅ᵢ), fᵢ₊₁=S_{2ID,i}(x̅ᵢ₊₁) are functional parameters of the ID-spline;
∇Iᵢⁱ⁺¹=Iᵢⁱ⁺¹−fᵢhᵢ₊₁; Δfᵢ₊₁=fᵢ₊₁−fᵢ.

For instance, a conventional trapezoidal rule

$${I}_{i}^{i + 1} = \frac{{f}_{i} + {f}_{i + 1}}{2} \cdot {h}_{i + 1} ,$$

or other quadrature formulas, can be used to calculate Iᵢⁱ⁺¹.

For links S_{2ID,i}(x) , the joining condition has been fulfilled:

S_{2ID,i}=S_{2ID,i+1}(x̅ᵢ₊₁) at i=0, . . . , n−2.

The formula (1) is equivalent to the following formula derived from (1) by replacing the variable

$$u = \frac{x - {\overline{x}}_{i}}{{h}_{i + 1}} :$$

$${S}_{2 I D , i} ( u ) = ( - 6 {u}^{2} + 6 u ) \frac{{I}_{i}^{i + 1}}{{h}_{i + 1}} + ( 3 {u}^{2} - 4 u + 1 ) {f}_{i} + ( 3 {u}^{2} - 2 u ) {f}_{i + 1} , \qquad ( 2 )$$

where

$$u = \frac{x - {\overline{x}}_{i}}{{h}_{i + 1}} \qquad ( 0 \leq u \leq 1 ) .$$

Then the ID-spline's formula will take the following form:

$${S}_{2 I D} ( u ) = {{⋃}_{i = 0}}^{n - 1} {S}_{2 I D , i} ( u ) . \qquad ( 3 )$$

The derivative S′_{2ID}(x) of the ID-spline exists and is continuous on the interval (x̅₀, x̅ₙ) if the following relation holds:

$$\frac{1}{{h}_{i}} {f}_{i - 1} + 2 ( \frac{1}{{h}_{i}} + \frac{1}{{h}_{i + 1}} ) {f}_{i} + \frac{1}{{h}_{i + 1}} {f}_{i + 1} = 3 ( \frac{{I}_{i}^{i + 1}}{{h}_{i + 1}^{2}} + \frac{{I}_{i - 1}^{i}}{{h}_{i}^{2}} ) , \\ i = 1 , . . . , n - 1. \qquad ( 4 )$$

The formula (4) is a tridiagonal linear system with diagonal predominance, which, in combination with two boundary-value equations, has a sole solution.

When calculating the values fᵢ (i=0, . . . , n) from the linear system (4) using the known values Iᵢⁱ⁺¹ (i=0, . . . , n−1) with the addition of two boundary-value equations (so that the linear system has a sole solution), the condition of differentiability of the ID-spline S_{2ID}(x) on the interval (x̅₀, x̅ₙ) is fulfilled.

The boundary-value equations used to calculate fᵢ (i=0, . . . , n) from the system of linear equations (4) may comprise, for example, formulas (derived from the conventional trapezoidal rule):

$${f}_{0} + {f}_{1} = \frac{2 {I}_{0}^{1}}{{h}_{1}} , {f}_{n - 1} + {f}_{n} = \frac{2 {I}_{n - 1}^{n}}{{h}_{n}} , \qquad ( 5 )$$

or the values of the ID-spline at points x̅₀, x̅ₙ, if they are known:

f₀=S_{2ID}(x̅₀)=F₀, fₙ=S_{2ID}(x̅ₙ)=Fₙ, (6)

where F₀, Fₙ are some known numbers.

Also, the first equation from (5) and the second equation from (6) can be taken as boundary conditions. Alternatively, the first equation from (6) and the second equation from (5) can be taken as boundary conditions. Other equations describing the boundary conditions for a particular problem can also be taken.

The boundary-value equations are chosen depending on which boundary values are known in the given problem. If F₀, Fₙ are known, then the formula (6) can be used. If I₀¹ and Iₙ₋₁ⁿ are known, then the formula (5) can be used. When the signals are processed by an ID-spline-based activation function as part of the neural network (having trainable parameters Iᵢⁱ⁺¹ or

$$\frac{{I}_{i}^{i + 1}}{{h}_{i + 1}} ( i = 0 , … , n - 1 ) ) ,$$

all values Iᵢⁱ⁺¹ (i=0, . . . , n−1), and, particularly, values I₀¹ and Iₙ₋₁ⁿ are known before the values fᵢ (i=0, . . . , n) are calculated from the linear system (4) at each iteration of training of the neural network (and during its actual operation). So, it is advisable to choose boundary-value equations (5), since, in this case, the values f₀, f₁ and fₙ₋₁, fₙ depend on the integral parameters I₀¹ and Iₙ₋₁ⁿ of the ID-spline correspondingly, which are trainable parameters of the neural network. Therefore, f₀, f₁ and fₙ₋₁,fₙ , along with I₀¹ and Iₙ₋₁ⁿ, will change at each training iteration, which will, occasionally, allow to speed up activation function changes during training thus shortening the neural network's training time and improving neural network's accuracy.

In the proposed technical solution, integral parameters Iᵢⁱ⁺¹ or transformed integral parameters

$$\frac{{I}_{i}^{i + 1}}{{h}_{i + 1}} ( i = 0 , … , n - 1 )$$

are trainable (learnable) parameters of the neural network, i.e. they change during training so as to improve the accuracy of results produced by the ANN. Parameters Iᵢⁱ⁺¹ are usually used when the step of the grid of nodes θ is regular, and parameters

$$\frac{{I}_{i}^{i + 1}}{{h}_{i + 1}}$$

are used when the step is variable. The grid of nodes θ has a regular step if h₁=h₂= . . . =hᵢ₊₁= . . . =hₙ=h=const, where hᵢ₊₁=x̅ᵢ₊₁−x̅ᵢ. A grid of nodes with a regular step is known as a uniform grid of nodes. The gird of nodes θ has a variable step if hᵢ≠hᵢ₊₁ for any i∈{1, 2, . . . , n−1}. At each iteration of training of the neural network the ID-spline-based activation function is formed based on the formula (3) from links (2) (the link joining condition is fulfilled when S_{2ID,i}(x̅_{i +1})=S_{2ID,i+1}(x̅ᵢ₊₁) at i=0, . . . , n−2) using the parameters

$${I}_{i}^{i + 1} ( or \frac{{I}_{i}^{i + 1}}{{h}_{i + 1}} ) ( i = 0 , … , n - 1 )$$

that have been updated at the previous iteration and the parameters fᵢ (i=0, . . . , n) that have been derived from them (with the help of the linear system (4) with two boundary-value equations, e.g. (5)). Before the neural network is trained, the initial values of the parameters

$${I}_{i}^{i + 1} ( or \frac{{I}_{i}^{i + 1}}{{h}_{i + 1}} ) ( i = 0 , … , n - 1 )$$

(i.e. the values used at the first training iteration) have to be calculated. The methods for calculating the initial values of the parameters

$${I}_{i}^{i + 1} ( or \frac{{I}_{i}^{i + 1}}{{h}_{i + 1}} ) ( i = 0 , … , n - 1 )$$

are described below.

At each training iteration, the value of the ID-spline-based activation function has to be calculated for each value x that is inputted into the ID-spline-based activation function, using the formula (2) of polynomial S_{2ID,i}(u) (which is the ID-spline link), where the number i is the index of the node x̅ᵢ of the grid θ that is the left boundary of the half-interval into which the value x “fell”: x∈[x̅ᵢ, x̅ᵢ₊₁). (The wording “the value x “fell” into the interval [x̅ᵢ, x̅ᵢ₊₁)” means that x∈[x̅ᵢ, x̅ᵢ₊₁).)

Training the Instance of the Created ANN.

Various methods (approaches) can be used to train an instance of the created ANN.

In some embodiments, the created neural network is trained “with a teacher” or “partially with a teacher”.

In some embodiments, the created neural network is trained “without a teacher” or “with the help of reinforcement learning”.

The ANN is trained with a training set (dataset). In some embodiments, the dataset can be marked (annotated) either manually, or semi-automatically, or in a fully automatic mode. Manual marking is made with the assistance of a specialist/expert/user. In some embodiments, specialized environments and means of data marking can be used, such as Computer Vision Annotation Tool (CVAT), NLab Marker, Cloud Annotations, etc.

Some practical aspects related to the definition and calculation of the activation function during training are described below.

Usually, an instance of the ANN is trained as follows. Before the training starts, the initial values of the trainable parameters are set. A training dataset comprises a plurality of observations, wherein each observation is a (generally) multidimensional array of signals—numbers (i.e. a set of attributes of a single object, or a single encoded image, or a single encoded word, but not limited to them). The training lasts for several “epochs” (the number of epochs is configured by the user/developer and may range from several epochs to several thousand epochs, or more). During a single epoch, the neural network (i.e. each layer one after another) processes the entire training set (or a major part thereof, since certain observations are sometimes discarded). The training set is usually divided into parts (batches/packets) that are inputted into the neural network one by one. Each batch comprises a number of observations from the training dataset (e.g. 16, 32, 64, 128, etc. observations). Sometimes the observations for each batch are randomly selected from the training dataset. The process of going through a single batch is known as a training iteration. Thus, a single epoch comprises a number of iterations equal to the number of batches the training set has been divided into. After each iteration, the trainable parameters of the neural network are corrected.

At each training iteration, a batch of input signals is sent to the input of the first layer of the ANN. Then, the signals from the batch are processed by each layer of the ANN, including the activation functions which are part of the ANN structure, one by one. For each subsequent layer, the input batch will comprise the output signals of the previous layer. The last layer of the ANN outputs a batch of output signals of the ANN. Then, the value of an error function (also, loss function) is calculated, which indicates the disparity between the ANN output and the desired result (for instance, when training “with a teacher”, it is the disparity between the ANN output and a set of known results). Then, the trainable parameters of the ANN are corrected such that the value of the loss function is reduced. In some embodiments, in order to minimize the value of the loss function, various modifications of the gradient descent method are used: SGD, Adagrad, RMSProp, Adadelta, Adam, Adamax,—but not limited thereto). (See, for example, the paper “An overview of gradient descent optimization algorithms”, Sebastian Ruder, https://arxiv.org/abs/1609.04747; Francois Chollet “Deep Learning with Python”, ISBN-10: 9781617294433.) The trainable (learnable) parameters of the ANN in all its layers are corrected using the method of backpropagation (https://en.wikipedia.org/wiki/Backpropagation): the trained parameters of the last layer are updated first, then the trainable parameters of the second to last layer are updated, and so on, until the first layer is reached. The training ends based on a specified criterion, e.g. when the value of the loss function at some iteration is less than the threshold value, but not limited to it. Sometimes, after certain training iterations, the neural network is tested using a test (validating) dataset, and so, the training may be considered to be finished based on the accuracy of the results of processing a test (validating) dataset.

In some embodiments, for ANNs comprising a small number of neurons (e.g. less than 100), a separate activation function (which is an ID-spline-based activation function or a combined ID-spline-based activation function) is trained (i.e. the coefficients of parabolic polynomials that making up the ID-spline are optimized) for each neuron irrespective of other neurons. Thus, for each neuron, there is a dedicated (trained) instance of the activation function, which is changed during training independently.

For more complex neural networks (i.e. having more neurons), it is proposed to use a single activation function (instance) (which is an ID-spline-based activation function or a combined ID-spline-based activation function) for all neurons in a given layer while having different instances for different layers. In this case, coefficients of parabolic polynomials of an ID-spline-based or a combined ID-spline-based activation function for a certain layer are changed during training irrespective of other layers' activation functions. In such architecture, the ID-spline-based activation function or the combined ID-spline-based activation function is trained separately for each respective layer during training, and after the training has a unique form that corresponds to its layer.

Signals that are processed by the neural network are attributes of certain objects and generally form multidimensional numerical arrays. Such multidimensional object (multidimensional array) is known as a “tensor”.

In case the ANN has one or more ID-spline-based or combined ID-spline-based activation functions, the integral parameters Iᵢⁱ⁺¹ or transformed integral parameters

$$\frac{{I}_{i}^{i + 1}}{{h}_{i + 1}}$$

of each ID-spline (representing the activation function) are trainable parameters of the neural network, along with neuron weights. As was mentioned above, in some sources, the step of using an activation function is considered to be among the steps performed by neurons of a certain layer (in this case, the activation function is considered to be a part of this layer), and in some sources, the activation function is considered to be a separate ANN layer (an activation layer). The difference between these two approaches does not affect the actual operation of the ANN, but affects the way it is described. In some known software libraries (such as PyTorch), the step of applying an activation function to signals is performed by a separate ANN layer.

To create a trained instance of an ANN with one or more ID-spline-based activation functions, before the training is started, it is necessary to do the following for each ID-spline-based activation function:

1) To create a grid of nodes for the ID-spline:

θ={x̅₀, . . . , x̅₁, . . . , x̅ᵢ, . . . , x̅ₙ}, where x̅₀<x̅₁< . . . <x̅ᵢ< . . . <x̅ₙ are real numbers (grid nodes).

2) To select a function φ₀(x) initializing the ID-spline-based activation function (ID-spline). As φ₀(x), one may take a known activation function applied for problems similar to the problem to be solved, for example,

$$ReLU ( x ) = \{ \begin{matrix}0 x < 0 \\ x x \geq 0\end{matrix}$$

or its modification (Noisy ReLU, Leaky ReLU, parametric ReLU, etc.),

$$ELU ( x ) = \{ \begin{matrix}α \cdot ( {e}^{x} - 1 ) & x < 0 \\ x & x \geq 0\end{matrix} ,$$

sigmoid, hyperbolic tangent, SoftSign.

Further, it is required to calculate initial values of the parameters Iᵢⁱ⁺¹ (i=0, . . . , n−1): Iᵢⁱ⁺¹=f_{x̅}_{ᵢ}^{x̅}^{ᵢ₊₁}φ₀(x)dx. The integrals Iᵢⁱ⁺¹ may be either taken accurately by integrating φₒ(x) or calculated by using approximate quadrature formulas of computational mathematics, for example, a trapezoidal formula:

$${I}_{i}^{i + 1} = \frac{{\overline{f}}_{i} + {\overline{f}}_{i + 1}}{2} {h}_{i + 1} \qquad ( 7 )$$

having a second order of accuracy, or left- and right-side formulas:

$$\begin{matrix}{I}_{i - 1}^{i} = \frac{{h}_{i}^{3}}{6 {H}_{i}^{i + 1}} ( - \frac{1}{{h}_{i + 1}} {\overline{f}}_{i + 1} + \frac{{H}_{i}^{i + 1} {H}_{i}^{3 ( i + 1 )}}{{h}_{i}^{2} {h}_{i + 1}} {\overline{f}}_{i} + \frac{{H}_{2 i}^{3 ( i + 1 )}}{{h}_{i}^{2}} {\overline{f}}_{i - 1} ) , and & ( 8 ) \\ {I}_{i}^{i + 1} = \frac{{h}_{i + 1}^{3}}{6 {H}_{i}^{i + 1}} ( \frac{{H}_{3 i}^{2 ( i + 1 )}}{{h}_{i + 1}^{2}} {\overline{f}}_{i + 1} + \frac{{H}_{i}^{i + 1} {H}_{3 i}^{i + 1}}{{h}_{i} {h}_{i + 1}^{2}} {\overline{f}}_{i} - \frac{1}{{h}_{i}} {\overline{f}}_{i - 1} ) , & ( 9 )\end{matrix}$$

having a third order of accuracy,

where Hₚᵢ^{q(i+1)}=phᵢ+qhᵢ₊₁(p, q>0 are natural numbers);

f̅ᵢ=(x̅ᵢ) (i=0, . . . , n) are values of the initializing function φ₀(x) in the grid nodes θ:

θ={x̅₀, . . . , x̅₁, . . . , x̅ᵢ. . . . , x̅ₙ}, where x̅₀<x̅₁< . . . <x̅ᵢ< . . . <x̅ₙ.

With a uniform grid of nodes of the ID-spline (h=const), the formulas (8) and (9) take the simple form:

$${I}_{i - 1}^{i} = \frac{h}{12} ( - {\overline{f}}_{i + 1} + 8 {\overline{f}}_{i} + 5 {\overline{f}}_{i - 1} ) , {I}_{i}^{i + 1} = \frac{h}{12} ( 5 {\overline{f}}_{i + 1} + 8 {\overline{f}}_{i} - {\overline{f}}_{i - 1} ) . \qquad ( 10 )$$

In some embodiments, Gaussian noise—values of a normally distributed random variable with a mathematical expectation m=0 and a small variance σ² (the value σ² is selected depending on the length of the segment [x̅₀, x̅ₙ] according to the “three sigma rule”, so that

$$3 \cdot σ = \frac{{\overline{x}}_{n} - {\overline{x}}_{0}}{2} )$$

can be added to the set (selection) of values f̅ᵢ (e.g., in the amount of ˜10% of (n+1)), randomly selected from the set {f̅₀, f̅₁, . . . , f̅ᵢ, . . . , f̅ₙ} in accordance with uniform distribution.

In some embodiments, it is indicated/marked that the integral parameters of the ID-spline Iᵢⁱ⁺¹ or the transformed integral parameters

$$\frac{{I}_{i}^{i + 1}}{{h}_{i + 1}}$$

are trainable parameters.

During the training of an ANN instance, the trainable parameters of the ID-spline

$${I}_{i}^{i + 1} ( or \frac{{I}_{i}^{i + 1}}{{h}_{i + 1}} )$$

(i=0, . . . , n−1), along with the ANN neuron weights, are modified so as to improve the accuracy of the results produced by the ANN.

Then, using the found initial values of the integral parameters

$${I}_{i}^{i + 1} ( or \frac{{I}_{i}^{i + 1}}{{h}_{i + 1}} ) ( i = 0 , … , n - 1 ) ,$$

it is necessary to calculate the initial values of the parameters fᵢ (i=0, . . . , n) from the linear system (4) with the addition of boundary-value equations, e.g. (5).

So, as a result of calculating the initial values of the parameters

$${I}_{i}^{i + 1} ( or \frac{{I}_{i}^{i + 1}}{{h}_{i + 1}} ) ( i = 0 , … , n - 1 ) and {f}_{i} ( i = 0 , … , n ) ,$$

the ID-spline-based activation function will be initialized before training begins.

At the beginning of each ANN training iteration, the values

$${I}_{i}^{i + 1} ( or \frac{{I}_{i}^{i + 1}}{{h}_{i + 1}} ) ( i = 0 , … , n - 1 )$$

are known for each ID-spline-based activation function, since Iᵢⁱ⁺¹ are calculated as the integrals of φ₀(x) (as indicated above) before the first iteration, and

$${I}_{i}^{i + 1} ( or \frac{{I}_{i}^{i + 1}}{{h}_{i + 1}} ) ( i = 0 , … , n - 1 )$$

are corrected together with the neuron weights at the end of each iteration such that a value of a loss function is reduced (by using one of the following modifications of the gradient descent method: SGD, Adagrad, RMSProp, Adadelta, Adam, Adamax—but not limited thereto). The parameters

$${I}_{i}^{i + 1} ( or \frac{{I}_{i}^{i + 1}}{{h}_{i + 1}} )$$

of ID-spline-based activation functions, as well as neuron weights are updated (corrected) using the error backpropagation method, wherein the trainable parameters of the last ANN layer are updated first, then the trainable parameters of the second to last ANN layer are updated, and so on, until the first layer is reached (this includes the layers representing ID-spline-based activation functions). The corrected values are stored in memory and used in the next iteration.

At each training iteration, for each ID-spline-based activation function, first the functional parameters of the ID-spline fᵢ (i=0, . . . , n) from the linear system (4) with two boundary-value equations, e.g. (5), are calculated using the known values of the integral Iᵢⁱ⁺¹ (or transformed integral

$$\frac{{I}_{i}^{i + 1}}{{h}_{i + 1}} )$$

parameters of the ID-spline that were obtained at the previous training iteration.

Then, when the layers of the ANN process signals, a batch of data B_{X}^{k} generally comprising multimidensional tensors of numerical data Xₜ^{k} (t−1, . . . ,T) is sent to the input kth of the ID-spline-based activation function. The application kth of the ID-spline-based activation function to the batch B_{X}^{k} is determined by the formula (11) below (the number of the activation function k is omitted), which results in the batch of data B_{Y}^{k}. Descriptions of all tensors used in the formula (11) are given before the formula (11).

The functioning of the l-th layer of the neural network, after which the ID-spline-based activation function is called, is described below. For the sake of clarity, the serial number of the activation function (k) is omitted in the formulas and variable definitions and batch definitions below.

l-th layer of the neural network produces a batch (packet/set of signals) B_{X}, which is inputted into the ID-spline-based activation function and represents a tensor generally comprising multidimensional tensors Xₜ (t=1, . . . , T):

$${B}_{X} = ( \begin{matrix}{X}_{1} \\ … \\ {X}_{t} \\ … \\ {X}_{T}\end{matrix} ) .$$

Let's take the grid of nodes of an ID-spline:

θ={x̅₀, x̅₁, . . . , x̅ᵢ, . . . , x̅ₙ}, where x̅₀<x̅₁< . . . <x̅ᵢ< . . . <x̅ₙ.

To calculate element values of an output signal tensor of an ID-spline-based activation function:

$${B}_{Y} = ( \begin{matrix}{Y}_{1} \\ … \\ {Y}_{t} \\ … \\ {Y}_{T}\end{matrix} )$$

it is required to determine, for each element x of each tensor Xₜ from a batch B_{X}, a semi-range of a grid of nodes within which x falls: x∈[x̅ᵢ, x̅ᵢ₊₁). This is required to determine which of ID-spline components (i.e. which of ID-spline parameters Iᵢⁱ⁺¹, fᵢ, fᵢ₊₁) should be used to calculate an output value y for the given x: y=S_{2ID, i}(x), where i is defined according to the following condition: x∈[x̅ᵢ, x̅ᵢ₊₁).

Here, sets of output signals Yₜ (constituting a batch B_{Y}) are tensors (of the same dimension as corresponding tensors Xₜ from the batch B_{X} which is fed to the input of the ID-spline-based activation function).

Further, when describing elements of multi-dimensional (in general case, M-dimensional) arrays/tensors, a set of indices {j₀, . . . , j_{M}} of an element in an M-dimensional array/tensor will be denoted by one letter, for example, j (where j={j₀, . . . , f_{M}}).

The tensors Yₜ consist of elements yⱼ=S_{2ID,i}(xⱼ), where xⱼ is the element of the tensor Xₜ (for t=1, . . ., T).

Since it is customary to use tensor calculations when working with neural networks, you need to create the following tensors for each batch B_{X}, the tensors having the same sizes (dimensions) as B_{X}:

B_{ind}, the jth element of which (b_{ind}_{ⱼ}) represents the index i of the initial (left) point of the half-interval [x̅ᵢ, x̅ᵢ₊₁) of the grid θ, where the jth element (xⱼ) of the batch B_{X} has fallen; B_{ind1}, the jth element of which (b_{ind1}_{ⱼ}) represents the index i+1 of the point that marks the right boundary of the half-interval [x̅ᵢ, x̅ᵢ₊₁) of the grid θ, where the jth element (xⱼ) of the batch B_{X} has fallen;

B_{IH}, the jth element of which (b_{IH}_{ⱼ}) represents the value

$$\frac{{I}_{i}^{i + 1}}{{h}_{i + 1}} ,$$

where i is the index of the initial (left) point of the half-interval [x̅ᵢ, x̅ᵢ₊₁) of the grid θ, where the jth element (xⱼ) of the batch B_{X} has fallen;

B_{f} , the jth element of which (b_{f}_{ⱼ}) represents the value fᵢ, where i is the index of the initial (left) point of the half-interval [x̅ᵢ, x̅ᵢ₊₁) of the grid θ, where the jth element (xⱼ) of the batch B_{X} has fallen;

B_{f1} , the jth element of which (b_{f1}_{ⱼ}) represents the value fᵢ₊₁, where i+1 is the index of the point that marks the right boundary of the half-interval [x̅ᵢ, x̅ᵢ₊₁) of the grid θ, where the jth element (xⱼ) of the batch B_{X} has fallen;

Bᵤ, the jth element of which (bᵤ_{ⱼ}) represents the value

$$\frac{{x}_{j} - {\overline{x}}_{i}}{{h}_{i + 1}} ,$$

where i is the index or the initial (left) point of the half-interval [x̅ᵢ, x̅ᵢ₊₁) of the grid θ, where the jth element (xⱼ) of the batch B_{X} has fallen.

Then, using the formula derived from (2), tensor operations can be utilized to calculate:

B_{Y}=S_{2ID}(B_{X})==(−6Bᵤ²+6Bᵤ)B_{IH}+(3Bᵤ²−4Bᵤ²+1)B_{f}+(3Bᵤ²−2Bᵤ)B_{f1}. (11)

(In the formula (11), multiplication and addition are term-by-term multiplication and addition of tensors, correspondingly. In the descriptions of the tensors that are part of the formula (11), the wording “the element x has fallen into the half-interval [x̅ᵢ, x̅ᵢ₊₁)” means that x∈[x̅ᵢ, x̅ᵢ₊₁).)

At each training iteration (after the neural network has finished processing one batch from the training dataset), the ID-spline S_{2ID}(u) (defined by the formula (3)) changes its form due to changes in its integral parameters Iᵢⁱ⁺¹ or transformed integral parameters

$$\frac{{I}_{i}^{i + 1}}{{h}_{i + 1}} ( i = 0 , … , n - 1 )$$

and functional parameters fᵢ (i=0, . . . , n). The integral parameters Iᵢⁱ⁺¹ or transformed integral parameters

$$\frac{{I}_{i}^{i + 1}}{{h}_{i + 1}} ( i = 0 , … , n - 1 )$$

are trainable parameters of the neural network, along with neuron weights, and therefore, they are updated in each training iteration so as to improve the training result (i.e., in most neural network types, to minimize the loss function).

Activation functions (one or more) of the ANNs with known architectures can be replaced by the ID-spline-based or the combined ID-spline-based activation functions described herein. In some embodiments, when replacing the kth activation function in the ANN (let's call it φₖ(x)) with an ID-spline-based or a combined ID-spline-based activation function, it is recommended that the values of the integral parameters Iᵢⁱ⁺¹ of the ID-spline are initialized with integrals: Iᵢⁱ⁺¹=∫_{x̅}_{ᵢ}^{x̅}^{ᵢ₊₁} φₖ(x)dx (calculated exactly or approximately with a quadrature formula, e.g., a conventional trapezoid formula (7)), where i =0, . . . , n−1; x̅ᵢ are points on the grid of the nodes of the ID-spline.

In some embodiments, when replacing the kth activation function in the ANN (let's call it φₖ(x)) with an ID-spline-based or a combined ID-spline-based activation function, it is recommended that the values of the integral parameters Iᵢⁱ⁺¹ of the ID-spline are initialized with integrals: Iᵢⁱ⁺¹=∫_{x̅}_{ᵢ}^{x̅}^{ᵢ₊₁} ρₖ(x) dx (calculated exactly or approximately with a quadrature formula, e.g., a conventional trapezoid formula (7)), where i=0, . . . , n−1; x̅ᵢ are points on the grid of the nodes of the ID-spline; and ρₖ(x) is a function that has a similar form to φₖ(x).

For example, if

$${φ}_{k} ( x ) = ReLU ( x ) = \{ \begin{matrix}0 , x < 0 \\ x , x \geq 0\end{matrix} ,$$

then ReLU(x) or a similar one (e.g. ELU(x)) can be chosen as ρₖ(x).

$$ELU ( x ) = \{ \begin{matrix}α \cdot ( {e}^{x} - 1 ) , & x < 0 \\ x , & x \geq 0\end{matrix} ( here α is a real number ) .$$

Some modifications of known ANNs are provided by software libraries, already with trained neuron weights (calculated by training those ANNs using large data sets). For example, the torchvision.models module of the PyTorch software library provides the following ANNs with trained neuron weights: alexnet, vgg16, resnet18, squeezenet1_0, densenet161, inception_v3, googlenet, shufflenet_v2_x1_0, mobilenet_v2, resnext50_32x4d, wide_resnet50_2, mnasnet1_0, FCN ResNet50, FCN ResNet101, DeepLabV3 ResNet50, DeepLabV3 ResNet101, Faster R-CNN ResNet-50 FPN, Mask R-CNN ResNet-50 FPN, Keypoint R-CNN ResNet-50 FPN, ResNet 3D 18, ResNet MC 18, ResNet (2+1)D, but not limited to them. The keras.applications library provides the following ANNs with trained neuron weights: Xception, VGG16, VGG19, ResNet50, ResNet101, ResNet152, ResNet50V2, ResNet101V2, ResNet152V2, InceptionV3, Inception ResNetV2, MobileNet, MobileNetV2, DenceNet121, DenceNet169, DenceNet201, NASNetMobile, NASNetLarge, EfficientNetB0, EfficientNetB1, EfficientNetB2, EfficientNetB3, EfficientNetB4, EfficientNetB5, EfficientNetB6, EfficientNetB7, but not limited to them. Each known ANN (architecture) provided by software libraries is used to solve certain classes of tasks described by their authors.

To solve some problem, a user or developer may use an ANN that is applied for a suitable type of problems and provided by a software library together with trained neuron weights. The user or developer then should replace one or more activation functions in this ANN with the activation functions described herein and representing or comprising the ID-splines. Furthermore, in some embodiments, the user or developer may, by defining pre-trained weights (i.e. the ones provided by the software library) as initial values of neuron weights, complete the training of the ANN based on a dataset used in the problem solved by the user or developer.

In some cases, by using pre-trained neuron weights, it is possible to significantly reduce the training time.

The grid θ for the ID-spline-based activation function must be selected in each layer of the neural network (where the ID-spline-based activation function is used) such that all x inputted into the activation functions in the given layer “fall” into it:

∀x∈[x̅₀, x̅ₙ].

Therefore, it is very important that the values x inputted into the ID-spline activation function do not have a very large “spread” (i.e. distance between the minimum and maximum values x), otherwise it will require either a grid B with a many nodes, which will lead to increased training time and increased actual working time, or a large distance between the nodes, which will negatively impact the accuracy of the results produced by the neural network.

In case a combined ID-spline-based activation function is used, it is also generally advisable to reduce the “spread” of inputted values. For example, for activation functions of the form

$$A ( x ) = \{ \begin{matrix}G ( x ) & x \leq {\overline{x}}_{{begin \_ S}_{ID 2}} \\ {S}_{2 ID} ( x ) & x \geq {\overline{x}}_{{begin \_ S}_{ID 2}}\end{matrix} ,$$

where G (x̅_{begin_S}_{_{ID}}=S_{2ID}(x̅_{begin_S}_{_{ID2}}) is the condition of joining of a function G (x) and an ID-spline S_{2ID}(x) at the point x̅_{begin_S}_{_{ID2}} (x̅_{begin_S}_{_{ID2}} is a real number), it is important to reduce the “spread” of inputted values in the area x≥x̅_{begin_S}_{_{ID2}}.

In order to reduce the “spread” of inputted values for an ID-spline-based activation function or a combined ID-spline-based activation function, it is advisable to run the Batch Normalization procedure before the ID-spline-based or the combined ID-spline-based activation function is called. After Batch Normalization, the data at the activation function input will have a zero mean and variance=1. Functions (layers) that perform Batch Normalization are provided by popular software libraries for neural networks, such as PyTorch, Keras, Caffe program shell, etc. As mentioned above, a training dataset is usually divided into data packets (batches). In a single training iteration, a single batch of training data with the length of T is inputted into the neural network, and therefore, in the same iteration, the batch of training data with the length of T is inputted into the activation function in the given neural network layer:

$${B}_{X} = ( \begin{matrix}{X}_{1} \\ … \\ {X}_{t} \\ … \\ {X}_{T}\end{matrix} ) .$$

Each element Xₜ is a multidimensional tensor.

In some cases, Batch Normalization is performed as follows (but not limited to it). First, the mathematical expectation and variance of the packet (batch) is calculated:

$${μ}_{B} = \frac{1}{T} {\sum }_{t = 1}^{T} {X}_{t} , {σ}_{B}^{2} = \frac{1}{T} {\sum }_{t = 1}^{T} {( {X}_{t} - {μ}_{B} )}^{2} . \qquad ( 12 )$$

Then, values of Xₜ are normalized:

$${\hat{X}}_{t} = \frac{{X}_{t} - {μ}_{B}}{\sqrt{{σ}_{B}^{2} + ɛ}} ( t = 1 , … , T ) , \qquad ( 13 )$$

where ε is a scalar, a small constant used to ensure the stability of calculations (for example, ε=10⁻⁵ can be chosen).

Then, they are compressed by γ and shifted by β, wherein both these values are trainable parameters of the neural network:

Yₜ=\hat{X}ₜ·γ+β. (14)

All operations in formulas (12), (13), (14) are tensor operations, i.e. they are performed over all elements of tensors (in this case, term by term), that is μ_{B}, σ_{B}², \hat{X}ₜ, γ, β have the same dimensions as Xₜ.

In some embodiments, Batch Normalization is performed by layers from the PyTorch software library (e.g., torch.nn.BatchNorm1d, torch.nn.BatchNorm2d, torch.nn.BatchNorm3d, torch.nn.GroupNorm) that are included in the neural network.

In some embodiments, Batch Normalization is performed by layers from the Keras software library (e.g., tf. keras. layers.BatchNormalization) that are included in the neural network.

The Batch Normalization layer is placed before the activation function.

The grid of nodes θ=x̅₀, x̅₁, . . . , x̅ᵢ, . . . , x̅ₙ} of the ID-spline (where x̅₀<x̅₁< . . . <x̅ᵢ< . . . <x̅ₙ) can have either a variable step, where hᵢ≠hᵢ₊₁ for any i∈{1,2, . . . , n−1} (hᵢ₊₁=x̅ᵢ₊₁−x̅ᵢ), or with a regular step, where h₁=h₂= . . . .=h_{i±1}= . . . =hₙ=h=const.

In some embodiments, the boundaries of the grid of nodes x̅₀, x̅ₙ have to be selected such that all (or almost all) elements x of tensors inputted into the ID-spline-based activation function get inside the segment [x̅₀, x̅ₙ]. The boundary values may be selected by practical consideration, by analyzing (e.g. automatically or visually, by displaying them on the screen) the minimum and maximum values of the tensor elements inputted into the ID-spline-based activation function when different neural network architectures are tried out. The algorithm has to be adapted in case the value of any x goes beyond the left (x̅₀) or the right (x̅ₙ) boundaries of the grid. In this case, it is possible to correct x by assigning x=x̅₀ or x=x̅ₙ, correspondingly. If such cases are rare, it won't affect the training capability of the neural network.

It often happens that the majority of the signal tensor elements values inputted into the ID-spline-based activation function are located in the vicinity of the point x=0. In this case, it is advisable to make the grid “denser” around pointx=0. In other words, it is advisable to select a grid θ, such that for the nodes x̅_{k_l}< . . . <x̅ₖ< . . . <x̅_{k_r} (where k_l, k_r are numbers of grid nodes θ, x̅ₖ=0, x̅_{k_l}<0, x̅_{k_r}>0) the grid step hᵢ₊₁=−x̅ᵢ between adjacent nodes becomes shorter, the closer the nodes are to the point x̅ₖ=0:

h_{k_l+l}>h_{k_l+2}>. . . >hₖ; hₖ₊₁<hₖ₊₂< . . . <h_{k_r}.

It is advisable to select the boundaries and steps of the grid of nodes of the ID-spline by practical consideration, so that the neural network could train more effectively (with faster training speed and higher accuracy of results). For example, first experiments could start with 51 node with a regular step (symmetrically to the left and to the right of zero, including the point 0). If the steps are too small, then it may be possible that the segments of convexity/concavity in the ID-spline change too often, and the parabolic polynomials comprising the ID-spline won't be able to take the optimal form for result prediction.

By selecting an optimal grid of nodes, it is possible to improve the quality of results produced by the neural network.

The ID-spline formula is such that the complexity of calculations does not depend on whether a uniform grid of nodes is selected (where distances between the nodes are the same) or a non-uniform one (where distances between the nodes vary).

In some embodiments, in order to increase the accuracy of solving certain problems, a combination of activation functions is used. In some embodiments, the resulting value of the activation function may be determined by different functions and/or a combination of different functions in different ranges depending on input data values. In some embodiments, input signals of a neuron are converted to output signals depending on values of argument x such that the output signal is calculated/determined in one range of values of argument x by using the ID-spline-based activation function and in other range(s) of values of argument x by using other function(s) (i.e. the activation function comprises/includes the ID-spline and is a combined ID-spline-based activation function).

In practice, it sometimes happens that, during training, the ID-spline-based activation function takes an oscillating (“wavy”) form in the area x<0, and takes the form of a smooth curve in the area x≥0. If the oscillation period's length at x<0 is similar to that of the steps hᵢ₊₁=x̅ᵢ₊₁−xᵢ of the grid θ in the oscillation area, then spline oscillations may have a negative impact on the accuracy of the results produced by the neural network. When concavity/convexity changes so often, parabolic polynomials comprising the ID-spline cannot take the optimal form for the operation of the neural network. In case the ID-spline oscillates to the left of some point (e.g. to the left from zero), use of a combined ID-spline-based activation function as the activation function can help to improve the neural network accuracy. For example, the ID-spline S_{2ID}(x) can be used as the activation function in the area x≥x̅_{begin_S}_{_{ID2}}, and a different function G (x) can be used in the area x<x̅_{begin_S}_{_{ID}}.

(Here, x̅_{begin_S}_{_{ID2}} is a point that coincides with a node x̅ᵣ of the grid θ. In some cases, x̅_{begin_S}_{_{ID2}}≤0 is selected.)

In some embodiments, an activation function comprising an ID-spline (i.e. a combined

ID-spline-based activation function) can be used in the following form:

$$A ( x ) = \{ \begin{matrix}G ( x ) & x \leq {\overline{x}}_{{begin \_ S}_{ID 2}} \\ {S}_{2 ID} ( x ) & x \geq {\overline{x}}_{{begin \_ S}_{ID 2}}\end{matrix} , \qquad ( 15 )$$

where

G(x̅_{begin_S}_{_{ID2}})=S_{2ID}(x̅_{begin)S}_{_{ID2}}) (16)

The formula (16) is the condition for joining the function G (x) and an ID-spline S_{2ID}(X) at the point x̅_{begin_S}_{_{ID2}}.

In some embodiments, an activation function comprising an ID-spline (i.e. a combined ID-spline-based activation function) can be used in the following form:

$$A ( x ) = \{ \begin{matrix}{S}_{2 ID} ( x ) & x \leq {\overline{x}}_{join} \\ G ( x ) & x \geq {\overline{x}}_{join}\end{matrix} ,$$

where S_{2ID}(x̅ⱼₒᵢₙ)=G(x̅ⱼₒᵢₙ), x̅ⱼₒᵢₙ is some point. In some embodiments G (x) can be a spline (ID-spline or spline of other type) or other function. When using the activation function (15), the grid of nodes θ can be divided into two parts:

θ={x̅₀, x̅₁, . . . , x̅ᵢ, . . . , x̅ₙ}=θ_{left}∪θ_{right}:

θ_{left}={x₀^{left}, x̅₁^{left}, . . . , x̅ᵢ^{left}, . . . , x̅_{nleft}^{left}}, where x̅ᵢ^{left}=x̅ᵢ (i=0, . . . nleft),

wherein x̅_{nleft}^{left}=x̅_{begin_S}_{_{ID2}};

θ_{right}={x̅₀^{right}, x̅₁^{right}, . . . , x̅ᵢ^{right}, . . . , x̅_{nright}^{right}}, where

x̅ᵢ^{right}=x̅_{n-nright+i} (i=0, . . . , nright), wherein x̅_{nleft}^{left}=x̅₀^{right}=x̅_{begin_S}_{_{ID}}.

In some embodiments, in the formula (15) a piecewise linear function

$$G ( x ) = L ( x ) = {⋃}_{i = 0}^{nleft - 1} {L}_{i} ( x ) , \qquad ( 17 )$$

is considered to be G (x).

The function L(x) consists of links Lᵢ(x) that represent linear functions in segments [x̅ᵢ^{left}, x̅ᵢ₊₁^{left}], such that their joining condition is fulfilled:

Lᵢ(x̅ᵢ₊₁^{left})=Lᵢ₊₁(x̅ᵢ₊₁^{left})(i=0, . . . , nleft−2), (18)

and comprising the trainable parameters of the neural network.

Then the activation function comprising the ID-spline (combined ID-spline-based activation function) will have the following form:

$$A ( x ) = \{ \begin{matrix}L ( x ) & x \leq {\overline{x}}_{{begin \_ S}_{ID 2}} \\ {S}_{2 ID} ( x ) & x \geq {\overline{x}}_{{begin \_ S}_{ID 2}}\end{matrix} , where L ( {\overline{x}}_{{begin \_ S}_{ID 2}} ) = {S}_{2 ID} ( {\overline{x}}_{{begin \_ S}_{ID 2}} ) . \qquad ( 19 )$$

In this case, the piecewise linear function L(x) is constructed on the grid θ_{left}, and the ID-spline S_{2ID}(x) is constructed on the grid θ_{right}.

The link Lᵢ(x) in the segment [x̅ᵢ^{left}, x̅ᵢ₊₁^{left}] has the following form:

$${L}_{i} ( x ) = {λ}_{i} + ( {λ}_{i + 1} - {λ}_{i} ) \cdot \frac{x - {\overline{x}}_{i}^{left}}{{h}_{i + 1}} , \qquad ( 20 )$$

where

x̅ᵢ^{left} (i=0, . . . , nleft) are the nodes of the grid θ_{left};

hᵢ₊₁x̅ᵢ₊₁^{left}−x̅ᵢ^{left};

λᵢ, λᵢ₊₁ are the values of the function L(x) at the ends of the segment [x̅ᵢ^{left}, x̅ᵢ₊₁^{left}]:

λᵢ=L(x̅ᵢ^{left), λ}ᵢ₊₁=L(x̅ᵢ₊₁^{left}).

For links Lᵢ(x) of the form (20), the joining condition (18) is fulfilled.

Here, λᵢ (i=0, . . . ,nleft) are the trainable (learnable) parameters of the neural network which are changed at each training iteration so as to improve the results produced by the neural network.

If the activation function (19) is used, L(x) and S_{2ID}(x) are initialized with a known function or a combination of functions before the training of the neural network starts.

The method for initializing the ID-spline S_{2ID}(x) is described above.

If S_{2ID}(x) is initialized with a function φ₀(x) defined in the entire segment [x̅₀, x̅ₙ] (where x̅₀, x̅ₙ are the boundaries of the grid θ) (e.g., if φ₀(x) is one of the known activation functions, for example, ReLU, LeakyReLU, ELU, sigmoid, hyperbolic tangent), then L(x) , too, can be initialized with φ₀(x).

To achieve this, λᵢ=φ₀(x̅ᵢ^{left})(i=0, . . . , nleft) is set.

When the activation function (19) is used, in each training iteration, in order to solve the system of linear equations (4) and to construct the ID-spline on the grid θ_{right} (in this case, in the linear system (4) n=nright), the user/developer chooses one of the boundary-value equations, so that the joining condition (16) is fulfilled, e.g. choosing the first (leftmost) boundary-value equation of the form (6). To achieve this, in each training iteration, before fᵢ (i=0, . . . , nright) is calculated from the linear system (4) (in this case, in the linear system (4) n=nright), the following values have to be assigned: f₀=λ_{left},

then the joining condition (16), where G(x)=L(x), will be fulfilled: λ_{nleft}=L_{nleft} (x̅_{nleft}^{left})=S_{2ID,0}(x̅₀^{right})=f₀, where x̅_{nleft}^{left}=x₀^{right}=x̅_{begin_S}_{_{ID2}}.

In some embodiments, the second equation from (5) is chosen as the second boundary-value equation to calculate fᵢ (i=0, . . . , nright) from the linear system (4) (in this case, n=nright from the linear system (4)). The recommendations on how to chose boundary-value equations are given above.

In some embodiments, when creating an activation function comprising an ID-spline according to the formula (15), the function

$$G ( x ) = 0 or G ( x ) = ELU ( x ) = \{ \begin{matrix}α \cdot ( {e}^{x} - 1 ) & x < 0 \\ x & x \geq 0\end{matrix}$$

(where α is a real number), or a sigmoid:

$$G ( x ) = σ ( x ) = \frac{1}{1 + {e}^{- x}} ,$$

or a hyperbolic tangent:

$$G ( x ) = th ( x ) = \frac{{e}^{x} - {e}^{- x}}{{e}^{x} + {e}^{- x}} ,$$

but not limited to them, are chosen as G(x) (in the area x≤x̅_{begin_S}_{_{ID2}}).

In some embodiments, the integral Iᵢⁱ⁺¹ (or transformed integral

$$\frac{{I}_{i}^{i + 1}}{{h}_{i + 1}} )$$

and/or functional f ᵢ, fᵢ₊₁ parameters of the ID-spline links are used as “embeddings” (“embedding”—vector representation is a common name for various approaches to language modeling and training of representations in natural language processing, aimed at matching words from a certain dictionary of vectors (codes) from Rⁿ (Rⁿ is a set of vectors of length n consisting of real numbers) for n, which is a significantly smaller number of words in the dictionary).

Below is a description of the calculation the values of the tensor elements used in formula (11) (by which the output signals of the ID-spline activation function are calculated) using “embeddings”.

Parameters

$${I}_{i}^{i + 1} ( or \frac{{I}_{i}^{i + 1}}{{h}_{i + 1}} )$$

are the trainable parameters of the neural network and are updated at each training iteration so as to improve the training results (i.e., in most neural network types, to minimize the loss function). Usually, the loss function minimum is found using the gradient descent method or the modifications thereof. These methods use gradients of the loss function by the trainable parameters of the neural network. Software libraries that contain functions for neural networks (e.g. PyTorch, Keras) provide a method for automatic differentiation, which involves the tracking of all operations with the trainable parameters of the neural network. Information about operations is stored in special fields of tensor objects (e.g. in PyTorch it is the grad_fn field) that have been calculated with the help of trainable parameters. As a result, it is possible to find the gradient of the loss function by the trainable parameters (because the value of the loss function was calculated using these parameters) at the end of each iteration of ANN training. It is done using the so-called backpropagation procedure (see https://en.wikipedia.org/wiki/Backpropagation, https://towardsdatascience.com/understanding-backpropagation-algorithm-7bb3aa2P95fd) based on the rule for calculating the derivative of a complex function.

In order to find the tensors B_{IH},B_{f},B_{f1} used in the formula (11), tensor operations can be used, respectively:

B_{JH}=IH[B_{ind}], B_{f}=f[B_{ind}], B_{f1}=f[Bᵢₙ], where

$$IH = ( \frac{{I}_{0}^{1}}{{h}_{1}} , … , \frac{{I}_{i}^{i + 1}}{{h}_{i + 1}} , … , \frac{{I}_{n - 1}^{n}}{{h}_{n}} ) , f = ( {f}_{0} , … , {f}_{i} , … , {f}_{n} )$$

are the vectors of the ID-spline parameters. The other notations are explained above the formula (11).

However, due to the way the backpropagation process is implemented in some popular software libraries, e.g. PyTorch, this method for calculating the values of tensor elements B_{IH} (where IH is the vector containing the trainable parameters) involves suboptimal calculations that take significantly (about 10 times) more time than if the “embedding” method described below is used.

An additional “embedding” layer is introduced into the neural network layer representing an ID-spline-based activation function, that is configured such that the integral parameters Iᵢⁱ⁺¹ (or transformed integral parameters

$$\frac{{I}_{i}^{i + 1}}{{h}_{i + 1}} )$$

of the ID-spline are trained. To achieve this, the following steps are taken if

$$\frac{{I}_{i}^{i + 1}}{{h}_{i + 1}}$$

is used (if Iᵢⁱ⁺¹ is used instead, the steps remain the same).

The vector IH is transformed into a two-dimensional array of “embeddings” (i.e. “codes”) for the elements of the tensor B_{ind}:

$${IH}_{emb} = [ \begin{matrix}[ \frac{{I}_{0}^{1}}{{h}_{1}} ] \\ … \\ [ \frac{{I}_{i}^{i + 1}}{{h}_{i + 1}} ] \\ … \\ [ \frac{{I}_{n - 1}^{n}}{{h}_{n}} ]\end{matrix} ] \qquad ( 21 )$$

and B_{IH} is calculated using a neural network layer of the “Embedding” type (from the PyTorch or Keras software libraries) with the array IH_{emb} as the trainable parameters (“weights”) of this layer. (Then, B_{IH} is the output tensor from the “Embedding” layer, and B_{ind} is the input tensor).

In this case, the “embeddings” are used to “encode” the elements of the tensor B_{ind} (see tensor definitions above the formula (11)) with the values

$$\frac{{I}_{i}^{i + 1}}{{h}_{i + 1}} ,$$

where Iᵢⁱ⁺¹ are the integral parameters of the ID-spline, hᵢ₊₁=x̅ᵢ₊₁−x̅ᵢ. This embodiment of the training method allows to calculate gradients much faster using automatic differentiation with the help of the backpropagation (“backward”) method (e.g. from the PyTorch or Keras software libraries).

For example, the corresponding fragments of the program code in Python using the PyTorch software library may look like this (the program variables are described using notations from the formula (11) given above the formula (11)).

The program variables are described below: ih_start is a vector

$$[ \frac{{I}_{{start}_{0}}^{1}}{{h}_{1}} , … , \frac{{I}_{{start}_{i}}^{i + 1}}{{h}_{i + 1}} , … \frac{{I}_{{start}_{n - 1}}^{n}}{{h}_{n}} ] ,$$

where Iₛₜₐᵣₜ_{ᵢ}ⁱ⁺¹(i=0, . . . , n−1) are the initial (before the neural network training is started) values of integrals of φ₀(x) (which is the initializing function for ID-spline) in the segments [x̅ᵢ, x̅ᵢ₊₁] of the grid θ (integrals can be calculated exactly or approximately: Iₛₜₐᵣₜ_{ᵢ}ⁱ⁺¹=∫_{x̅}_{ᵢ}^{x̅}^{ᵢ₊₁} φ₀(x)dx or Iₛₜₐᵣₜ_{ᵢ}ⁱ⁺¹≈∫_{x̅}_{ᵢ}^{x̅}^{ᵢ₊₁} φ₀(x)dx, methods for initializing the ID-spline and calculating the initial values of its integral parameters are described above);

b_ind is a tensor B_{ind};

b_ih is a tensor B_{IH};

emb_layer_integ is a link to an instance (object) of the torch.nn.Embedding class.

Then, before the training is started (e.g. in the_init_(constructor) method of the ID_spline class in Python that was created by the user/developer to process the signals using an ID-spline-based activation function) the following operator is called (the from_pretrained method of the torch.nn.Embedding class):

emb_layer integ=torch.nn.Embedding.from_pretrained(torch.unsqueeze(ih_start, dim=1), freeze=False)

The emb_layer_integ variable is stored in the computer's memory, e.g. in the_init_(constructor) method of the ID_spline class, as follows:

self.emb_layer_integ=emb_layer_integ,

to be used in the training of the neural network.

At each training iteration (e.g., in the forward method of the ID_spline class), the following operator is executed to calculate the tensor B_{IH}:

b_ih=self.emb_layer_integ(b_ind).squeeze( )

The trainable parameters (tensor IH_{emb}) are stored in the self .emb_layer_integ.weight field of the self.emb_layer_integ object and are updated at each training iteration.

If the function (19), which is a combination of a piecewise linear function and an ID-spline (such embodiment is described above), is used as the activation function, then a two-dimensional array of “embeddings” is created for the piecewise linear component with trainable parameters Lᵢ (i=0, . . . ,nleft):

$${L}_{emb} = [ \begin{matrix}[ {λ}_{0} ] \\ … \\ [ {λ}_{i} ] \\ … \\ [ {λ}_{nleft} ]\end{matrix} ]$$

and then, in order to calculate the values of the piecewise linear component of the activation function, a neural network layer of the “Embedding” type or a similar one (from the PyTorch or Keras software libraries) is used with the array L_{emb} as the trainable parameters (“weights”) of this layer. To calculate the ID-spline component of function (19), “embeddings” are used as described above.

In some embodiments, a matrix solution for a system of linear equations is used to find the parameters of the ID-spline.

At each training iteration, after the trainable parameters

$${I}_{i}^{i + 1} or \frac{{I}_{i}^{i + 1}}{{h}_{i + 1}} ( i = 0 , … , n - 1 )$$

of the neural network are updated, it is necessary to find the parameters fᵢ (i=0. . . , n) from the linear system (4) with the addition of two boundary-value equations (e.g. (5)) to construct the ID-spline. The linear system (4) is a tridiagonal system of linear equations, which can be solved by using a known iteration-based method, known as a tridiagonal matrix algorithm, Thomas algorithm (see https://en.wikipedia.org/wiki/Tridiagonal_matrix_algorithm), where the coefficients are first calculated in the cycle of i=1, . . . , n−1, and then fᵢ in the “reverse” cycle of i=n−1, . . . , 0. However, when calculations are performed on a GPU (graphics processing unit), matrix operations are performed faster than cycles. Therefore, in some embodiments, the linear system (4) is solved/calculated using functions for achieving a matrix solution. For example, the following functions can be used: torch.solve, torch.cholesky_solve from the PyTorch software library; tf.linalg.tridiagonal_solve, tf.linalg.solve, tf.linalg.cholesky_solve from the TensorFlow software library, etc.

In some embodiments, if an NVIDIA GPU is used, special functions for solving tridiagonal linear systems from the cuSPARCE software library (by NVIDIA) are used, which perform operations with sparse matrices.

Below are the descriptions of some additional aspects of the embodiments of the present technical solution.

A neural network trains and operates much faster using a graphics processor unit or units (GPU). Therefore, if the computer comprises a GPU, it is advisable that the neural network processes the signals using the GPU.

In some embodiments, in order to reduce the “spread” of the input values for the ID-spline-based or the combined ID-spline-based activation function, the Batch Normalization procedure is run before calling the ID-spline or the combined ID-spline activation function.

After performing Batch Normalization before calling the activation function, the data at the activation function input will have a zero mean and variance=1. That is, the tensor elements x inputted into the ID-spline-based activation function or the combined ID-spline-based activation function are located to the left and right of the point 0.

The boundaries x̅₀, x̅ₙ of the grid of nodes for the ID-spline-based activation function or the combined ID-spline-based activation function (of the form (19)) have to be selected by the user/developer such that all (or almost all) elements x of tensors inputted into the activation function get within the boundaries of the segment [x̅₀, x̅ₙ]. The algorithm has to be adapted in case the value of any x goes beyond the left (x̅₀) or the right (x̅ₙ) borders of the grid. In this case, it is possible to correct x by assigning x=x̅₀ or x=x̅ₙ, correspondingly. If such cases are rare, it won't affect the training capability of the neural network.

For a combined ID-spline-based activation function of the form (15)-(16), if G(x) is defined for the entire area x<X_{begin_S}_{_{ID2}}, then the right boundary of the grid of nodes x̅ₙ=x_{nright}^{right} for the ID-spline S_{2ID}(x) has to be selected such that all (or almost all) elements x of tensors inputted into the activation function get into the area x<x̅ₙ. The algorithm has to be adapted in case the value of any x exceeds that of the right boundary (x̅ₙ) of the grid. Then, it is possible to correct x by assigning x=x̅ₙ. If such cases are rare, it won't affect the training capability of the neural network.

If the majority of the tensor elements x inputted into the ID-spline-based activation function or the combined ID-spline-based activation function of the form (19) are located in the vicinity of point 0, it is advisable to make the grid “denser” around the point 0. In other words, it is advisable to select a grid θ, such that for the nodes x̅_{k_l}< . . . <x̅ₖ< . . . <x̅_{k_r} (where k_l, k_r are numbers of grid nodes θ, x̅_{k_l}=0, x̅_{k_r}>0) the grid step hᵢ₊₁=x̅ᵢ₊₁−x̅ᵢ between adjacent nodes becomes shorter, the closer the nodes are to the point x̅ₖ=0.

For a combined ID-spline-based activation function of the form (15)-(16) in case x̅_{begin_} [symbol] ≤0 it is also recommended to make the grid of spline nodes “denser” in the vicinity of point 0. If the most elements x, such that x≥x̅_{begin_S}_{_{ID2}}, that are inputted into the combined ID-spline-based activation function of the form (15)-(16) (i.e. elements that have got into the definition area of the ID-spline S_{2ID}(x)), are located in the vicinity of point 0, it is advisable to select a grid of nodes of the ID-spline such that the grid step between S_{2ID}(x), such that the grid step between adjacent nodes becomes shorter, the closer the nodes are to the point 0.

In some embodiments, a modification of the method for calculating the values of the ID-spline-based activation function is used—one that involves “embeddings” used to calculate the trained integral parameters Iᵢⁱ⁺¹ (or transformed integral parameters

$$\frac{{I}_{i}^{i + 1}}{{h}_{i + 1}} )$$

of the ID-spline, wherein also, in case an activation function of the form (19) is used, which is a combination of a piecewise linear function and an ID-spline, the “embeddings” can be used to calculate both the trainable parameters

$${I}_{i}^{i + 1} ( or \frac{{I}_{i}^{i + 1}}{{h}_{i + 1}} )$$

of the ID-spline and the trainable parameters λᵢ, of a piecewise linear function.

Since the signals that “go through” the neural network (i.e. that are processed by its layers) are processed using tensor computations (implemented with software libraries, such as PyTorch, Keras, TensorFlow, etc. that are utilized in neural network development), it is advisable to call functions from these software libraries that provide matrix solutions for systems of linear equations, in order to calculate the parameters fᵢ (i=0, . . . , n) of the ID-spline-based activation function from a tridiagonal linear system (4) (together with two boundary-value equations). If an NVIDIA GPU is also used, then it is advisable to use special functions from the cuSPARCE software library (by NVIDIA), which carry out operations with sparse matrices, to solve tridiagonal linear systems.

The ID-spline-based activation function represents an ID-spline. The combined ID-spline-based activation function comprises an ID-spline. To find the parameters of the ID-spline, it is required to solve the system of linear equations (4), which is supplemented by two boundary equations to ensure the uniqueness of the solution. In some embodiments, equations (5) or (6) or other equations can be used as boundary equations, depending on the conditions of the problem being solved. Formula (6) can be applied if the values of F₀, Fₙ are known.

When using the ID-spline-based activation function (3), it is advisable to choose boundary-value equations (5), since, in this case, the values f₀, f₁ and fₙ₋₁, fₙ depend on the integral parameters I₀¹ and Iₙ₋₁ⁿ of the ID-spline correspondingly, which are trainable parameters of the neural network, therefore f₀, f₁ and fₙ₋₁, fₙ together with I₀¹ and Iₙ₋₁ⁿ, will change at each training iteration, which will, occasionally, allow to speed up activation function changes during training thus shortening the neural network's training time.

When utilizing a combined ID-spline-based activation function (19), which is a combination of a piecewise linear function and an ID-spline, to solve a system of linear equations (4) in order to calculate the parameters fᵢ (i=0, . . . , nright), the first (leftmost) boundary-value equation should be

$${f}_{0} = {λ}_{nleft} = {L}_{nleft} ( {\overline{x}}_{{begin \_ S}_{ID 2}} ) ,$$

where λ_{nleft} is the value of the piecewise linear function in the point where it meets the ID-spline: x̅_{begin_S}_{_{ID}} (λ_{nleft} is changed at each training iteration, which, in turn, causes changes in f₀). The second boundary-value equation should be an equation of the form (5), since, in this case, the values f_{nright-1}, f_{nrigh} depend on the integral parameter of the ID-spline I_{nright-1}^{nright}, which is a trainable parameter of the neural network, therefore f_{nright-1}, f_{nright}, together with I_{nright-1}^{nright} will change at each training iteration, which will, occasionally, allow to speed up activation function changes during training thus shortening the neural network's training time.

Below are some exemplary results of experimental use of ID-splines as activation functions in ANN layers.

Based on these experiments, the results of using the ID-spline activation function and those of using the conventional activation function

$$ReLU ( x ) = \{ \begin{matrix}0 x < 0 \\ x x \geq 0\end{matrix}$$

are compared.

The experiments were run on a computer with the following specs: CPU: AMD Ryzen 5 2600 Six-Core Processor, 3.40 GHz; memory (RAM): 16 GB; GPU: NVIDIA GeForce RTX 2070 SUPER with the following specs:
8192 MB GDDR6 video memory;
core/memory clock speed: 1815/14000 MHz;
universal processing units: 2560.

Development environment: Jupiter Notebook.

The computations were made on a GPU using Compute Unified Device Architecture (CUDA), a software-hardware architecture for parallel computations that allows to significantly increase computing performance thanks to NVIDIA GPUs. CUDA compiler driver (nvcc): NVIDIA (R) Cuda compiler driver, Cuda compilation tools, release 11.0, V11.0.167.

Programming language: python 3.7 with the PyTorch machine learning framework (v 1.6.0) and software libraries NVIDIA CUDA® Deep Neural Network (cuDNN v 7605), torchvision.datasets (from PyTorch), numpy (v 1.19.1), pandas (v 1.1.2), matplotlib (v 3.3.2), ctypes (v 0.2.0), NVIDIA® cuSPARSE Library (v 11.1.0).

The experiments were run to classify clothing items from a popular FashionMNIST dataset that is part of the torchvision.datasets software module of the PyTorch software library.

FashionMNIST is a dataset containing images of clothes from the Zalando catalogue. The FashionMNIST dataset is divided into a Training Set containing 60,000 images and a Test Set containing 10,000 images. Each element of the dataset is a monochrome image 28×28 pixels, labeled as belonging to one of the 10 classes:

0: T-shirt/top, 1: Trouser, 2: Pullover, 3: Dress, 4: Coat,

5: Sandal, 6: Shirt, 7: Sneaker, 8: Bag, 9: Ankle boot.

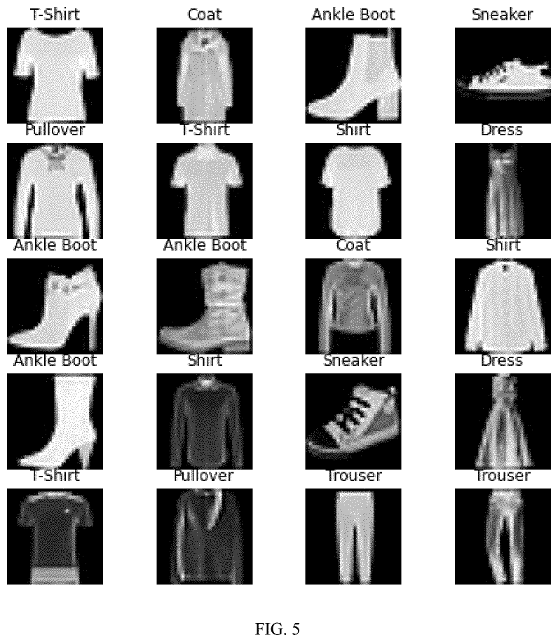

These images look like those shown in FIG. 5 (a random sample from the FashionMNIST dataset).

Three neural networks have been generated and trained using the Training Set dataset:
IDSplineNet, with both activation functions being ID-spline-based;
ReluIDSplineNet, with the first activation function being a ReLU function, and the second being an ID-spline-based function; and
ReluNet, with both activation functions being ReLU functions.

```
IDSplineNet neural network configuration:
IDSplineNet(
  (conv1): Conv2d(1, 16, kernel_size=(5, 5), stride=(1, 1), padding=(2, 2))
  (bn1): BatchNorm2d(16, eps=1e−05, momentum=0.1, affine=True, track_running_stats=True)
  (fa1): IDSAF(
    (init_fun): ELU(alpha=0.2)
    (emb_I): Embedding(41, 1)
  )
  (pool1): MaxPool2d(kernel_size=2, stride=2, padding=0, dilation=1, ceil_mode=False)
  (conv2): Conv2d(16, 32, kernel_size=(5, 5), stride=(1, 1), padding=(2, 2))
  (bn2): BatchNorm2d(32, eps=le-05, momentum=0.1, affine=True, track_rurming_stats=True)
  (fa2): IDSAF(
    (init_fun): ELU(alpha=0.2)
    (emb_I): Embedding(31, 1)
  )
  (pool2): MaxPool2d(kernel_size=2, stride=2, padding=0, dilation=1, ceil_mode=False)
  (drop): Dropout(p=0.6, inplace=False)
  (fc): Linear(in_features=1568, out_features=10, bias=True)
)
ReluIDSplineNet neural network configuration:
ReluIDSplineNet(
(conv1): Conv2d(1, 16, kernel_size=(5, 5), stride=(1, 1), padding=(2, 2))
  (bn1): BatchNorm2d(16, eps=le-05, momentum=0.1, affine=True, track_rurming_stats=True)
  (relu): ReLU( )
  (pool 1): MaxPool2d(kernel_size=2, stride=2, padding=0, dilation=1, ceil_mode=False)
  (conv2): Conv2d(16, 32, kernel_size=(5, 5), stride=(1, 1), padding=(2, 2))
  (bn2): BatchNorm2d(32, eps=1e−05, momentum=0.1, affine=True, track_rurming_stats=True)
  (fa2): IDSAF (
    (init_fun): ELU(alpha=0.2)
    (emb_I): Embedding(31, 1)
  )
  (pool2): MaxPool2d(kernel_size=2, stride=2, padding=0, dilation=1, ceil_mode=False)
  (drop): Dropout(p=0.6, inplace=False)
  (fc): Linear(in_features=1568, out_features=10, bias=True)
)
ReluNet neural network configuration:
ReluNet(
  (conv1): Conv2d(1, 16, kernel_size=(5, 5), stride=(1, 1), padding=(2, 2))
  (bn1): BatchNorm2d(16, eps=1e−05, momentum=0.1, affine=True, track_running_stats=True)
  (fa1): ReLU( )
  (pool1): MaxPool2d(kernel_size=2, stride=2, padding=0, dilation 1, ceil_mode=False)
  (conv2): Conv2d(16, 32, kernel_size=(5, 5), stride=(1, 1), padding=(2, 2))
  (bn2): BatchNorm2d(32, eps=le-05, momentum=0.1, affine=True, track_running_stats=True)
  (fa2): ReLU( )
  (pool2): MaxPool2d(kernel_size=2, stride=2, padding=0, dilation 1, ceil_mode=False)
  (drop): Dropout(p=0.6, inplace=False)
  (fc): Linear(in_features=1568, outfeatures=10, bias=True)
)
```

Here, Conv2d, BatchNorm2d, MaxPool2d, Dropout, Linear are classes (neural network layers) from the torch.nn module of the PyTorch software library; IDSAF is a class that implements the ID-spline-based activation function; and ReLU is a class that implements the ReLU activation function from the torch.nn software module of the PyTorch software library. IDSAF uses the following classes from the torch.nn module of the PyTorch software library: ELU (containing a function that initializes the values of the ID-spline-based activation function before training) and Embedding (containing an embedding layer that is used to calculate integral parameters of the ID-spline and values of the ID-spline-based activation function). Activation functions in these three neural networks are used after each of the two pairs of layers: {convolutional layer Conv2d, batch normalization layer BatchNorm2d}. (BatchNorm2d is batch normalization that is used, as mentioned above, to reduce the spread of values inputted into the activation function).

The loss function torch.nn.CrossEntropyLoss (from the torch.nn module of the PyTorch software library) and the gradient optimization function torch.optim.Adam (from the torch.optim module of the PyTorch software library) with learning rate equal to 0.001 were used in training.

The size of a single data batch is 64, the number of training epochs is 50, the function initializing the values of the ID-spline before training is ELU with the parameter α=0.2.

Grids of nodes for ID-spline-based activation functions IDSAF (instances of the IDSAF class):
points of the segment [−20.0, 20.0] with a constant step of 1.0 for the IDSAF function called after the first pair of layers: {Conv2d, BatchNorm2d};
points of the segment [−15.0, 15.0] with a constant step of 1.0 for the IDSAF function called after the second pair of layers: {Conv2d, BatchNorm2d}.

The experiment was run to compare the accuracy of classification of clothing items from the FashionMNIST test dataset, the classification performed by the IDSplineNet, ReluIDSplineNet, and ReluNet neural networks described above.

The accuracy of these neural networks was checked using the FashionMNIST test dataset containing 10,000 images.

For each image, the neural network was able to predict its class (type of clothing) and compare the predicted class with the true class.

The IDSplineNet neural network has yielded the following results:

Accuracy of T-shirt/top: 87.20%

Accuracy of Trouser: 99.00%

Accuracy of Pullover: 88.90%

Accuracy of Dress: 95.40%

Accuracy of Coat: 88.60%

Accuracy of Sandal: 97.30%

Accuracy of Shirt: 84.70%

Accuracy of Sneaker: 97.00%

Accuracy of Bag: 98.90%

Accuracy of Ankle boot: 97.60%

Mid Accuracy=93.46%

learning time=16m 3s

The ReluIDSplineNet neural network has yielded the following results:

Accuracy of T-shirt/top: 87.60%

Accuracy of Trouser: 99.00%

Accuracy of Pullover: 87.60%

Accuracy of Dress: 94.40%

Accuracy of Coat: 90.80%

Accuracy of Sandal: 98.10%

Accuracy of Shirt: 79.30%

Accuracy of Sneaker: 97.40%

Accuracy of Bag: 98.00%

Accuracy of Ankle boot: 96.70%

Mid Accuracy=92.89%

learning time=10m 54s

The ReluNet neural network has yielded the following results:

Accuracy of T-shirt/top: 86.90%

Accuracy of Trouser: 99.10%

Accuracy of Pullover: 86.10%

Accuracy of Dress: 93.80%

Accuracy of Coat: 87.00%

Accuracy of Sandal: 97.20%

Accuracy of Shirt: 77.00%

Accuracy of Sneaker: 95.40%

Accuracy of Bag: 98.10%

Accuracy of Ankle boot: 97.50%

Mid Accuracy=91.81%

learning time=6m 48s

Here, for each i th class (i =0, . . . ,9) of clothing:

$${Accuracy}_{i} = \frac{\begin{matrix}Number of correctly classified \\ items of the i th class\end{matrix}}{Total number of items of the i th class} \cdot 100 \% ;$$

$$Mid Accuracy = \frac{{\sum }_{i = 0}^{9} {Accuracy}_{i}}{10} .$$

“learning time” is the time of neural network training, where m is minutes and s is seconds.

Experiments show that the IDSplineNet neural network with two ID-spline-based activation functions produces more accurate results than the ReluNet neural network with two ReLU activation functions. Also, the ReluIDSplineNet neural network with ReLU being the first activation function and the second being an ID-spline-based activation function, produces more accurate results than the ReluNet neural network with two ReLU activation functions. Experiments also show that despite an ID-spline-based activation function having a more complex formula (i.e. comprising parabolic polynomials) than the formula

$$ReLU ( x ) = \{ \begin{matrix}0 x < 0 \\ x x \geq 0\end{matrix} ,$$

and requiring parameters fᵢ (i =0, . . . , n) to be calculated from the linear system (4) (together with two boundary-value equations) that comprises equations which total n+1, the number of nodes in the ID-spline grid, the time needed to train an ANN with ID-spline-based activation functions is not much higher than that of ANNs with ReLU activation functions:
the training time of the ReluIDSplineNet neural network with ReLU being the first activation function and the second being an ID-spline-based activation function is 10 min 54 sec, which is approximately 1.6 times longer than that of the ReluNet neural network with two ReLU activation functions (6 min 48 sec);
the training time of the IDSplineNet neural network with two ID-spline-based activation functions is 16 min 3 sec, which is approximately 2.36 times longer than that of the ReluNet neural network with two ReLU activation functions (6 min 48 sec).

An increase in the training time (due to the complexity of the ID-spline formula compared to ReLU and the need to solve the linear system (4) with the number of equations equal to the number of spline grid nodes) is the acceptable price for significantly better accuracy of the ANN with ID-spline-based activation functions.

While the IDSplineNet and ReluIDSplineNet neural networks were being trained, their ID-spline-based activation functions changed their forms. This was caused by changes in integral parameters Iᵢⁱ⁺¹ of ID-splines (which are trainable parameters), as well as dependent parameters fᵢ of ID-splines (see formulas (2-5)) that took place during training. The parameters Iᵢⁱ⁺¹, which are being trainable, change such that the neural network produces more accurate results.

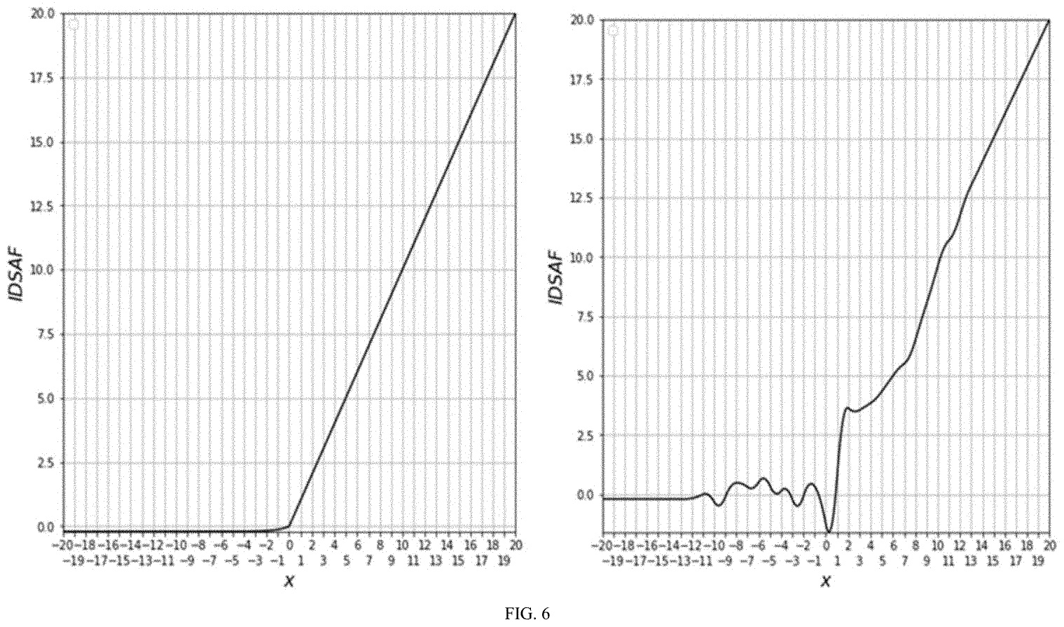

FIG. 6 shows the ID-spline-based activation function (IDSAF) that is called after the first pair of layers {Conv2d, BatchNorm2d} are executed, before training (left panel) and after training (right panel) of the IDSplineNet neural network.

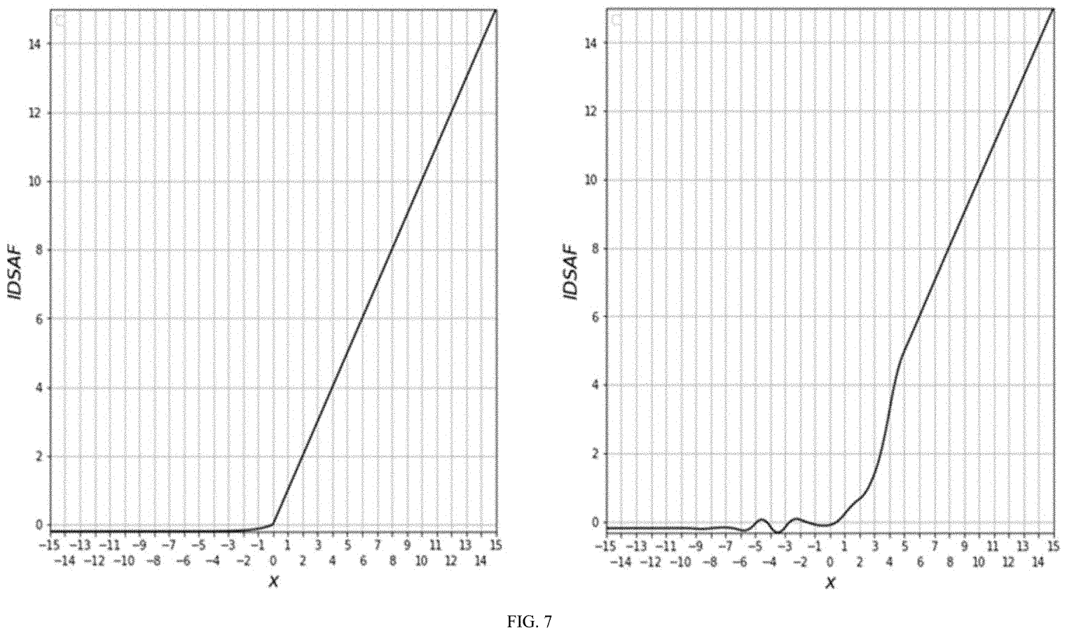

FIG. 7 shows the ID-spline-based activation function (IDSAF) that is called after the second pair of layers {Conv2d, BatchNorm2d} are executed, before training (left panel) and after training (right panel) of the IDSplineNet neural network.

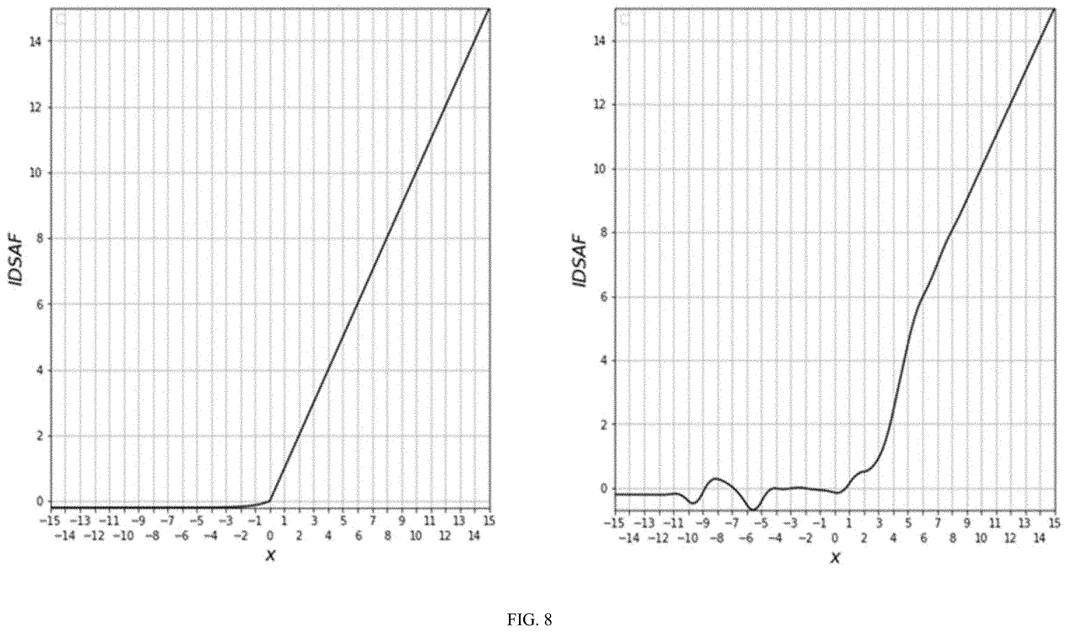

FIG. 8 shows the ID-spline-based activation function (IDSAF) that is called after the second pair of layers {Conv2d, BatchNorm2d} are executed, before training (left panel) and after training (right panel) of the ReluIDSplineNet neural network.

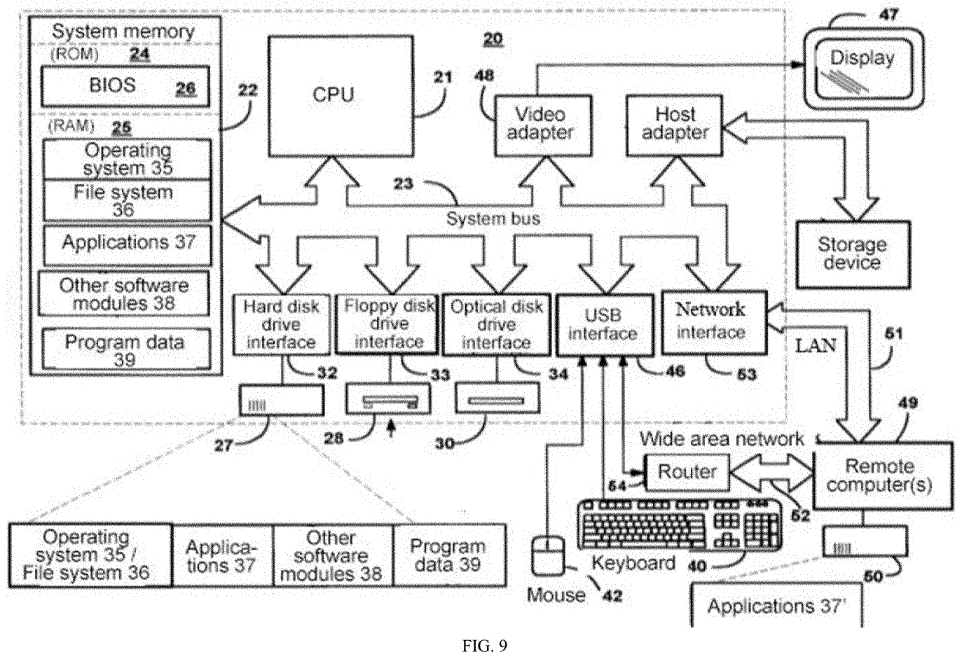

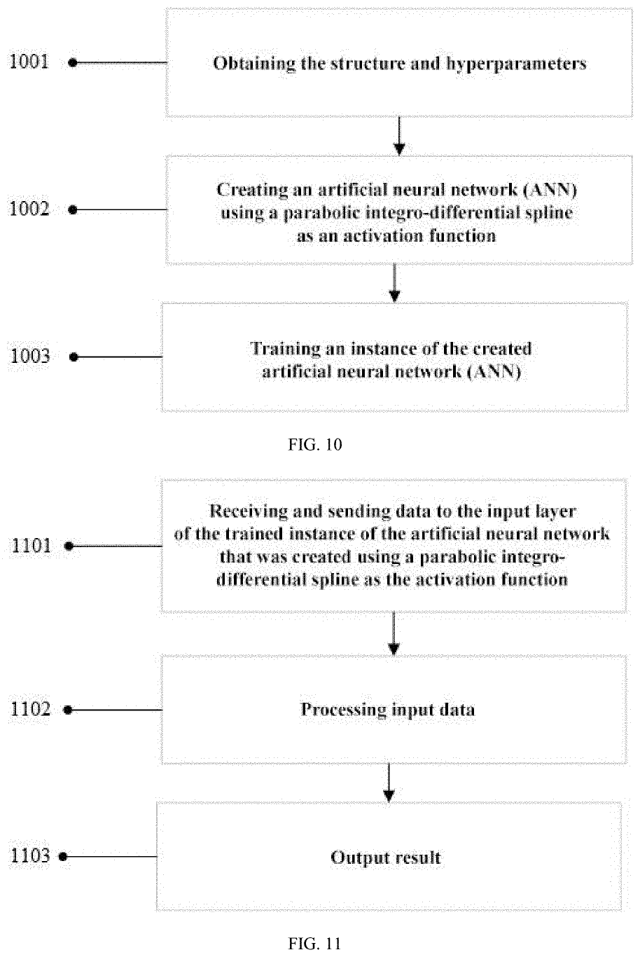

FIG. 9 illustrates an exemplary general-purpose computer system that is used in some embodiments to implement the proposed method—an exemplary personal computer, or an exemplary server 20 comprising a CPU 21, a system memory 22 and a system bus 23 that carries various components of the system, including the memory connected to the CPU 21. The system bus 23 is made according to any conventional bus structure comprising a bus memory or a bus memory controller, a peripheral bus, and a local bus, which is capable of interacting with any other bus-based architecture. The system memory comprises a read-only memory (ROM) 24 and a random access memory (RAM) 25. The basic input/output system (BIOS) 26 comprises basic procedures enabling data exchange between the components of a personal computer (PC) 20, e.g. when an operating system is loaded using the ROM 24.

The PC 20 comprises, in turn, a hard disk drive (HDD) 27 for writing and reading data, a floppy disk drive 28 for writing and reading data to and from floppy disks 29, and an optical disk drive 30 for writing and reading data to and from optical disks 31, such as CD-ROM, DVD-ROM, or other optical data carriers. The hard disk drive 27, the floppy disk drive 28 and optical disk drive 30 are connected to the system bus 23 via a hard disk drive interface 32, a floppy disk drive interface 33 and an optical disk drive interface 34 correspondingly. The drives and their corresponding data carriers represent non-volatile means for storing computer-executable instructions, data structures, program modules, and other PC 20 data.

According to the present disclosure, there is provided a system comprising an HDD 27, but it should be appreciated by those skilled in the field that other computer data carriers can also be used, which are capable of storing data in computer-readable form such as solid-state drives, flash drives, digital disks, RAM, etc., that are connected to the system bus 23.

The computer 20 has a file system 36 storing an operating system 35, together with additional software applications 37, other program modules 38 and program data 39. The user is able to input instructions and information into the PC 20 via input devices, i.e. the keyboard 40 and mouse 42. Other input devices may also be user (not illustrated in the figure): a microphone, a joystick, a gaming console, a scanner, etc. Such input devices are, conventionally, connected to the computer system 20 via a USB interface 46, which is, in turn, connected to the system bus. However, these devices may be connected in a different manner, e.g. via a parallel port, or a MIDI-port (gameport). The monitor 47, or another display, is also connected to the system bus 23 via an interface, e.g. a video card 48. Besides the monitor 47, the PC may be equipped with other peripheral output devices (not illustrated in the figure).

The PC 20 is capable of working in a network environment, using a network connection to one or multiple remote computers 49. The one or multiple remote computers 49 are similar PCs or servers comprising the same number of components illustrated in FIG. 9 that describes the composition of the PC 20, or a majority thereof. The computing network may further comprise other devices, such as routers, network stations, P2P devices, or other network nodes.

Network connections may together form both a local area network (LAN) 50 and a wide area network (WAN). Such networks are used in corporate computer networks, internal company networks, usually having access to the Internet. Both in LAN and WAN, the PC 20 is connected to the LAN 50 via a network card or network interface 51. When accessing a network, the PC 20 may use a router 54 or other means of accessing a WAN, such as the Internet. The router 54, which may be either internal or external, is connected to the system bus 23 via the USB-port 46.

Please note that the network connections shown in the figure serve illustrative purposes only and do not describe the exact network configuration, i.e. there are different technical ways available to establish network connection between computers.

In some embodiments, data processing, calculations and other operations according to the proposed technical solution can be performed by graphics processing units (GPUs, such as graphics cards) as well as by specialized neural processing units (NPUs) or AI accelerators. Machine-readable and data can be stored either in RAM, in the graphics card's memory, or elsewhere, where they can be read and processed.

Below are some exemplary embodiments of the technical solution disclosed herein implemented in Python, one of the possible programming languages, using the PyTorch software library.

The ID_spline_calc function calculates the value of the ID-spline-based activation function using the formula (11). Input and output parameters, as well as internal function variables, are described in terms that have been used to describe the formula (11) and its constituent tensors.

Function Input Parameters:

inp (type: torch.float32)—tensor B_{X} used as an input of the activation function;

x_grid (type: torch.float32)—a one-dimensional array of length n+1, comprising a grid of ID-spline nodes θ: θ={x̅₀, x̅₁, . . . , x̅ᵢ, . . . , x̅ₙ}, where x̅₀<x̅₁< . . . <x̅ᵢ< . . . <x̅ₙ in terms of the above description;

dx (type: torch.float32)—the size of the step of ID-spline's grid of nodes (here, a regular-sized grid of nodes has been selected: dx=h₁=h₂= . . . =hᵢ₊ᵢ= . . . =hₙ);

I_gridvalues (type: torch.float32)—a one-dimensional length [I₀¹, I₁², . . . , Iᵢⁱ⁺¹, . . . , Iₙ₋₁ⁿ] array n, comprising the values of an integral of the ID-spline in segments [x̅ᵢ, x̅ᵢ₊₁] of the ID-splines grid of nodes (the elements of the I_gridvalues array are trainable parameters of the neural network);

f_gridvalues (mm: torch.float32)—a one-dimensional array [f₀, f₁, . . . , fᵢ, . . . , fₙ] of length n+1, comprising the functional parameters of the ID-spline (these parameters are calculated from the system of linear equations (4) and equations (5) using I_gridvalues at each training iteration).

Internal Function Variables:

ind (type: torch.int32)—tensor B_{ind};

ind1 (type: torch.int32)—tensor B_{ind1};

x_grid_tensor (type: torch.float32)—tensor (of the same dimension as inp), wherein each element is the left endpoint x̅ᵢ of the semi-range [x̅ᵢ, x̅ᵢ₊₁) of the ID-spline's grid of nodes, into which the corresponding element of the inp tensor “has got” (“the inp tensor element that corresponds to the x_grid_tensor element” meaning that “the inp tensor element has the same indices in the array/tensor as the x_grid_tensor element”);

Ih_tensor (type: torch.float32)—tensor B_{IH};

f_tensor (type: torch.float32)—tensor B_{f};

fl_tensor (type: torch.float32)—tensor B_{f1};

u (type: torch.float32)—tensor Bᵤ;

u2, a0, a1, a2 (type: torch.float32)—tensors for storing intermediate values during calculations (see the program code below).

Function Output Parameter:

ID_spline_tensor (type: torch.float32)—tensor B_{Y} containing the values of the ID-spline.

def ID_spline_calc(inp, x_grid, dx, I_gridvalues, f_gridvalues):

ind=((inp.sub(x_grid[0])).div(dx)).floor( )long( )

ind1=ind.add(1)

x_grid_tensor=x_grid [ind]

Ih_tensor=(I_gridvalues[ind]).div(dx)

f_tensor=f_gridvalues[ind]

fl_tensor=f_gridvalues[ind1]

u=(inp.sub(x_grid_tensor)).div(dx)

u2=u*u

a0 =u2*(−6.0)+u*6.0

a1=u2*(3.0)+u*(−4.0)+1.0

a2=u2*(3.0)+u*(−2.0)

ID_spline _tensor=a0*Ih_tensor+a1*f_tensor+a2*fl_tensor return ID_spline_tensor

In conclusion, it should be noted that the details given in the description are examples that do not limit the scope of the present technical solution as defined by the claims.

What is claimed is:

1. A computer-implemented method for creating a trained instance of an artificial neural network (ANN), comprising the following steps:
1defining an ANN structure and hyperparameters;
creating, by at least one processor, the ANN to be stored in a memory based on the defined ANN structure and hyperparameters, the ANN comprising an ANN input layer, one or more ANN hidden layers, an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential spline
$${S}_{2 ID} ( x ) = {⋃}_{i = 0}^{n - 1} {S}_{2 ID , i} ( x ) ,$$
the parabolic integro-differential spline having coefficients of parabolic polynomials S_{2ID,i}(x), which comprise trainable parameters and change when training the created ANN; and
training the instance of the created ANN.

2. The method of claim 1, wherein the activation function is defined individually for each neuron of the ANN hidden layer and for each neuron of the ANN output layer.

3. The method of claim 1, wherein the activation function is defined individually for each of the ANN hidden layer and individually for the ANN output layer.

4. The method of claim 1, wherein the at least one processor comprises a central processing unit (CPU) or a graphics processing unit (GPU).

5. The method of claim 1, wherein the memory comprises a Random-Access Memory (RAM) or a video RAM.

6. The method of claim 1, wherein the ANN layer with the activation function representing or comprising the parabolic integro-differential spline comprises an embedding layer configured such that the parameters included in the coefficients of the parabolic integro-differential spline are trained.

7. The method of claim 1, wherein the parameters included in the coefficients of the parabolic integro-differential spline used as the activation function are determined by using a matrix solution of a system of linear equations.

8. A computer-implemented method for using a trained instance of an artificial neural network (ANN), comprising the following steps:
receiving and feeding input data to an input layer of the trained instance of the ANN, the ANN being created based on a predefined ANN structure and predefined ANN hyperparameters by using at least one processor, the ANN comprising an ANN input layer, one or more ANN hidden layers, and an ANN output layer, each of the ANN layers comprising at least one node, the nodes of the ANN hidden layers and the ANN output layer converting input signals to an output signal by using activation functions, wherein at least one of the activation functions represents or comprises a parabolic integro-differential spline
$${S}_{2 ID} ( x ) = {⋃}_{i = 0}^{n - 1} {S}_{2 ID , i} ( x ) ,$$
the parabolic integro-differential spline having coefficients of parabolic polynomials S_{2ID,i}(x) , which comprise trainable parameters and change when training the created ANN; and
processing the input data by using the trained instance of the ANN, thereby obtaining a resulting output.
